(19) United States
(12) Patent Application Publication
(10) Pub. No.: US 2025/0191175 A1
(43) Pub. Date: Jun. 12, 2025

(54) COMPUTER IMPLEMENTED METHOD FOR GENERATING AN AERIAL IMAGE OF A PHOTOLITHOGRAPHY MASK USING A MACHINE LEARNING MODEL

(71) Applicant: Carl Zeiss SMT GmbH, Oberkochen (DE)

(72) Inventors: Bjoern Brauer, Magstadt (DE); Bjoern Barz, Jena (DE); Alexander Freytag, Erfurt (DE); Bjoern Froehlich, Jena (DE); Xuan Truong Nguyen, Berlin (DE)

(21) Appl. No.: 18/971,089

(22) Filed: Dec. 6, 2024

(30) Foreign Application Priority Data
Dec. 9, 2023 (DE) 102023134517.6

(51) Int. Cl. G06T 7/00; G06T 7/30; G06T 11/00

(52) U.S. Cl. CPC G06T 7/001; G06T 7/30; G06T 11/00; G06T 2207/10032; G06T 2207/20081; G06T 2207/20084; G06T 2207/30148

(57) ABSTRACT

The invention relates to a computer implemented method for generating an aerial image of a photolithography mask in an image space, the method comprising: obtaining a representation of a design of the photolithography mask; applying a trained conditional diffusion model that is configured to sequentially revert a stochastic process to an initial sample in order to generate an aerial image of the photolithography mask, wherein the trained conditional diffusion model is conditioned on the representation of the design of the photolithography mask. The invention also relates to computer implemented methods for defect localization, alignment, repair shape generation, training data generation and corresponding systems.

### CROSS-REFERENCE TO RELATED APPLICATION

The present application claims the priority of the German patent application DE 10 2023 134 517.6, filed on Dec. 9, 2023, the entire contents of which are incorporated herein by reference.

### TECHNICAL FIELD

The invention relates to a computer implemented method, a computer-readable medium, a computer program product and corresponding systems for generating aerial images of photolithography masks. The method, computer-readable medium, computer program product and systems can be utilized for quantitative metrology, defect detection in photolithography masks, alignment of aerial images, photolithography mask improvement or repair, system generation or process control, process monitoring or process improvement.

### BACKGROUND

A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal and optical processes. Dimensions, shapes and placements of the semiconductor structures and patterns are subject to several influences. One of the most crucial steps is the photolithography process.

Photolithography is a process used to produce patterns on the substrate of a wafer. The patterns to be printed on the surface of the substrate are usually generated by computer-aided-design (CAD). From the design, for each layer a photolithography mask is generated, which contains a magnified image of the computer-generated pattern to be etched into the substrate. The photolithography mask can be further adapted, e.g., by means of optical proximity correction techniques. During the printing process an illuminated image projected from the photolithography mask is focused onto a photoresist thin film formed on the substrate. A semiconductor chip powering mobile phones or tablets comprises, for example, approximately between 80 and 120 patterned layers. In the past, when photolithography required less precision, the circuit layout equaled the mask pattern which equaled the wafer pattern.

Due to the growing integration density in the semiconductor industry, photolithography masks have to image increasingly smaller structures onto wafers. The aspect ratio and the number of layers of integrated circuits constantly increases and the structures are growing into 3^{rd} (vertical) dimension. The current height of the memory stacks is exceeding a dozen of microns. In contrast, the feature size is becoming smaller. The minimum feature size or critical dimension is below 20 nm, or even below 10 nm, for example 7 nm or 5 nm, and is approaching feature sizes below 3 nm in near future. While the complexity and dimensions of the semiconductor structures are growing into the 3^{rd} dimension, the lateral dimensions of integrated semiconductor structures are becoming smaller. Producing the small structure dimensions imaged onto the wafer requires photolithography masks or templates for nanoimprint photolithography with ever smaller structures or pattern elements. The production process of photolithography masks and templates for nanoimprint photolithography is, therefore, becoming increasingly more complex and, as a result, more time-consuming and ultimately also more expensive. With the advent of EUV photolithography scanners, the nature of masks changed from transmission-based patterning to reflection-based patterning.

Today, the minimum feature size on the mask has reached sub-wavelength dimensions. Consequently, the so-called optical proximity effect caused by non-uniformity of energy intensity due to optical diffraction during the exposure process occurs. As a result, images formed on the substrate do not faithfully reproduce the patterns on the photolithography mask.

Therefore, many applications require an aerial image of the photolithography mask. An aerial image generates the radiation intensity distribution at the substrate level of the photolithography mask or a subset thereof, preferably under EUV illumination of the photolithography mask. In this way, the aerial image allows for an analysis of the semiconductor structures that will be printed onto the substrate during the printing process. However, the generation of an aerial image is time-consuming and expensive. Therefore, methods for generating aerial images of photolithography masks have become important.

Among these methods, there are time-consuming rigorous generation methods such as finite difference time domain (FDTD) or rigorous coupled wave analysis (RCWA), and fast approximations such as the thin element approximation (TEA). Due to the heavy computational load for full-chip applications, rigorous generations are not suitable for use in commercial computational photolithography software. Fast approximations such as TEA are often not sufficiently accurate for tasks requiring high accuracy as in semiconductor industry. Therefore, there is a need for an accurate and fast generation method for aerial images of photolithography masks.

A known method for generating an aerial image of a photolithography mask is disclosed in U.S. Pat. No. 10,209,615 B2. The method uses a thin mask image as input and generates a near field image using a neural network comprising at least one of a multilayer perceptron (MLP) and a convolutional neural network (CNN). The neural network is trained using thin mask images and corresponding near field images that can be obtained using rigorous generation methods. MLPs and traditional CNNs, e.g., trained with standard L1 or L2 loss functions, have shown to be successful in solving image analysis tasks such as detection, recognition, segmentation, etc. However, for image generation tasks MLPs and traditional CNNs are less suitable and achieve results of lower accuracy. For image generation tasks, generative adversarial models (GANs) with additional adversarial loss have been used before. However, these have well-known problems during training, e.g., vanishing gradients, mode collapse, convergence failure, and, during inference, they are often prone to predict image artifacts, and they often do not cover the entire sample distribution.

It is, therefore, an aspect of the invention to obtain a generation method for aerial images with increased accuracy. It is another aspect of the invention to obtain a generation method for aerial images that requires low computation time. Another aspect of the invention is to reduce the required memory. It is another aspect of the invention to reduce the required user effort and expert knowledge. A further aspect of the invention is to improve photolithography mask design without the need to actually print a wafer. Another aspect of the invention is to detect defects in photolithography masks with high accuracy and at low computation times. Another aspect of the invention is to align aerial images of photolithography masks. Another aspect of the invention is to repair photolithography masks.

The aspects are achieved by the invention specified in the independent claims. Advantageous embodiments and further developments of the invention are specified in the dependent claims.

### SUMMARY

Embodiments of the invention concern computer implemented methods, a computer-readable medium, a computer program product, and corresponding systems for generating aerial images of photolithography masks, for detecting defects, for aligning aerial images, or for repairing photolithography masks.

An embodiment of the invention involves a computer implemented method for generating an aerial image of a photolithography mask in an image space, the method comprising: obtaining a representation of a design of the photolithography mask; applying a trained conditional diffusion model that is configured to sequentially revert a stochastic process to an initial sample in order to generate an aerial image of the photolithography mask, wherein the trained conditional diffusion model is conditioned on the representation of the design of the photolithography mask.

The generated aerial image can be used during quality control of the photolithography mask, in particular, for defect localization or defect detection in the photolithography mask, for repairing photolithography masks, or for aligning aerial images of the photolithography mask to the generated aerial image.

The photolithography mask may have an aspect ratio of between 1:1 and 1:4, preferably between 1:1 and 1:2, most preferably of 1:1 or 1:2. The photolithography mask may have a nearly rectangular shape. The photolithography mask may be preferably 5 to 7 inches long and wide, most preferably 6 inches long and wide. Alternatively, the photolithography mask may be 5 to 7 inches long and 10 to 14 inches wide, preferably 6 inches long and 12 inches wide. The term “photolithography mask” comprises transmission-based photolithography masks and reflection-based photolithography masks, e.g., EUV photolithography masks.

An aerial image refers to a type of image that is formed by the reflection or refraction of light. This can include images that are captured by a camera or viewed through a microscope, telescope, or another optical instrument. An aerial image is typically captured by a lens, which focuses the light onto a medium such as a film or a digital sensor. Aerial images can also be created through other means such as holography and interferometry.

A “representation of a design of the photolithography mask” refers to any kind of description of the design of the photolithography mask, e.g., in form of a 1D, 2D or 3D image and/or text and/or parameters, etc. An image can, for example, indicate the structure of integrated circuit patterns on the surface or other layers of the photolithography mask. An image can be a 2D cross-section image of the photolithography mask, or a 3D volumetric image of the photolithography mask. An image can, for example, indicate the material distribution within the photolithography mask, e.g., by using materials or material properties such as refractive indices, electric permittivities, magnetic permeabilities, etc. An image can contain structures in the form of polygons describing integrated circuit patterns. An image can contain semantic information, e.g., in the form of a semantic map that indicates information within a specific local region, for example, a type of integrated circuit pattern within a region of the photolithography mask. A text can, for example, describe the type of integrated circuit patterns on the photolithography mask, e.g., “memory” or “logical.” A text can also describe the location of specific integrated circuit patterns on the photolithography mask. The design of the photolithography mask can, for example, be indicated by use of a CAD file or some other kind of model of the photolithography mask. The representation of the design of the photolithography mask can, thus, be obtained from a CAD file or some other kind of model.

A “stochastic process” [symbol] refers to a collection of one or more potentially multivariate random variables Xₜ indexed by elements t∈ [symbol] from an index set [symbol] . A stochastic process [symbol] is characterized by the joint probability distributions of its random variables indexed by arbitrary finite subsets of the index set [symbol] . When the index set is a subset of the real numbers, the collection of random variables can be understood as a sequence of random variables, and the index set can be interpreted as time. As an example, the index set can be discrete and finite, e.g., 0≤t≤T which resembles a finite, discrete sequence of random variables X₀, . . . , X_{T} which can for example describe the state of a random quantity at each point in time t. A stochastic process can be used for modeling random, often temporarily ordered, processes. An example for a stochastic process is a Markov process. An example for a Markov process is a diffusion process.

A step of a stochastic process, also called a stochastic process step, refers to the transition of the probability distributions between two random variables Xₜ_{₁}, and Xₜ_{₂} t₁, t₂∈ [symbol] . In the example of a finite, discrete sequence of random variables, the transition from one time point t to the next time point t+1 is called a stochastic process step.

A diffusion model comprises a generative machine learning model that is configured to sequentially revert a stochastic process, preferably a diffusion process, in a reverse stochastic process. The diffusion model is configured to learn a distribution of image data. It sequentially transforms an initial sample from an initial random distribution into a sample of the learned distribution by sequentially applying a learned reverse stochastic process step to the initial sample. The learned reverse stochastic process step reverses a time step of the stochastic process by transforming an image (the initial sample in the first step or an intermediate result in a following step) to a reverse-transformed version of the image that is closer to the learned distribution. Closer here can, for example, mean with respect to a distance measure that measures the distance of the reverse-transformed version of the image to the manifold. Closer can also mean that the image is reverse-transformed in a way that should bring it closer to the manifold. The reverse stochastic process step can comprise estimating a difference between the image and the reverse-transformed version of that image, in particular a scaled difference, and subsequently computing the reverse-transformed version of the image using the estimated difference. In case of a noising process, the reverse stochastic process step can comprise estimating the noise according to a noise model and subsequently subtracting the noise from the image. A learned reverse stochastic process step is a method step that comprises at least one learning based task, but can also comprise other tasks. Diffusion models are, for example, described in “Denoising Diffusion Probabilistic Models, J. Ho, A. Jain, P. Abbeel, 2020, arXiv 2006.11239.”

The stochastic process can, for example, be a noising process, blurring process, pixelation process, masking process, morphing process, filtering process, etc. In a preferred embodiment, the stochastic process is a noising process, e.g., for Gaussian noise, salt and pepper noise, shot noise or some other kind of noise. In this case, the diffusion model is trained to sequentially denoise an initial sample, e.g., a Gaussian noise image with identically and independently distributed (i.i.d) Gaussian noise in each pixel, until reaching a solution that corresponds to the learned distribution of image data. A stochastic process maps an image to another image in the same space, e.g., in image space or a latent space.

During training of the diffusion model, the stochastic process is applied to an aerial image. The diffusion model is then trained to sequentially reverse the stochastic process to recover the original aerial image. During inference, aerial images are generated from initial samples. The initial samples can be generated randomly. The trained conditional diffusion model is applied to an initial sample that depends on the stochastic process of the trained conditional diffusion model. Preferably, the initial samples are of the same size as the aerial image to be generated by the diffusion model. For example, in case of a noising process the initial samples can be randomly generated noise samples, e.g., Gaussian noise samples. In case of a blurring, pixelation, masking, morphing or filtering process, the initial samples can comprise a homogeneous image of a single value. A trained diffusion model can then generate aerial images from initial samples, e.g., from random initial samples. In order to generate aerial images that correspond to the design of the photolithography mask, a conditional diffusion model is used. Conditional diffusion models use additional information as input to guide the image generation process. To use the design of the photolithography mask to guide the image generation process, the conditional diffusion model is conditioned on a representation of the design of the photolithography mask.

As conditional diffusion models are generative models, they are—in contrast to MLPs or traditional CNNs—well suited for generating aerial images. Due to their iterative nature, they can perform complex tasks in a highly accurate way and are more stable than one-step approaches that carry out image-to-image transformations in a single step. Due to the use of conditional information, they yield more accurate results than standard diffusion models.

In a preferred embodiment of the invention, the representation of the design of the photolithography mask describes the photolithography mask at least partially in a dimension orthogonal to a base plane of the photolithography mask. In this way, the representation of the design of the photolithography mask is not limited to a thin mask image but contains information on the internal structure of the photolithography mask. In this way, mask 3D effects can be prevented that result from neglecting the vertical dimension, the height, of the structures on the photolithography mask.

A typical mask 3D effect is, for example, mask shadowing. The chief ray angle (CRA) specifies the angle between the optical axis and the normal vector of the mask surface. The present EUV projection systems, for example, employ a CRA of 6°. Mask shadowing occurs due to the height of the absorber structures and the non-telecentric illumination at mask level, which modulates the captured intensity from the shadowed mask area through the reflective optics onto the wafer. At the wafer level, this causes asymmetric shadowing, an image shift and size bias depending on the feature orientation, and a shift of the process window.

Another mask 3D effect are phase shifts caused by the diffraction at the absorber structures. These phase effects generate imaging effects, which are very similar to phase deformations caused by wave aberrations of the projection systems.

Another mask 3D effect can be attributed to the reflective character of EUV photolithography masks. The dominant part of the reflected light originates from the multilayer, which is designed to provide a high reflectivity over a sufficiently large range of incidence angles. However, there is also some reflected light from the top of the absorber causing double images.

To obtain highly accurate aerial images, these mask 3D effects should not be ignored as is the case for approximation methods such as Kirchhoff's thin element approach. However, rigorous generations methods such as finite difference time domain (FDTD) or rigorous coupled wave analysis (RCWA) that take into account mask 3D effects are computationally not feasible. Therefore, using fast conditional diffusion models and representations of designs of photolithography masks that contain information in a dimension orthogonal to a base plane of the photolithography mask results in a fast and accurate aerial image generation process.

In a preferred embodiment of the invention, the trained conditional diffusion model is a trained latent conditional diffusion model that operates in a latent space of the image space and that comprises a mapping from the image space to the latent space and a mapping from the latent space to the image space. Conditional latent diffusion models are, for example, described in “High-Resolution Image Synthesis with Latent Diffusion Models, R. Rombach, A. Blattmann, D. Lorenz, P. Esser, B. Ommer, 2022, arXiv 2112.10752.” By using the conditional diffusion model in a latent space, the runtime is reduced due to the lower dimensionality of the latent space compared to the image space. Furthermore, the accuracy of the generated aerial images is improved, since only the most relevant information of the aerial images is preserved in the latent space, e.g., noise is removed. The mapping from the image space to the latent space and the mapping from the latent space to the image space can, for example, be carried out using a trained encoder—decoder machine learning model.

According to an aspect of the invention, the trained latent conditional diffusion model is conditioned on a representation of the design of the photolithography mask in latent space, and the representation of the design of the photolithography mask in latent space is obtained by applying a trained neural network, in particular a convolutional neural network, to the representation of the design of the photolithography mask. By applying the trained neural network to the representation of the design of the photolithography mask, the representation of the design of the photolithography mask can be mapped to another space, e.g., to the latent space, as well. This allows for an improved representation of the design of the photolithography mask that is adapted to the latent conditional diffusion model. In this way, more accurate aerial images can be generated.

According to an example, sequentially reversing the stochastic process comprises applying a learned reverse stochastic process step to the initial sample in a first time step and to the result of the respective previous reverse stochastic process step in all following time steps, wherein the learned reverse stochastic process step reverses a time step of the stochastic process. For example, in each time step a denoising operation is applied, to the initial sample in the first time step and to the results of the previous reverse stochastic process step in the following time steps.

The sequential application of a reverse stochastic process step can be implemented in different ways.

Preferably, the learned reverse stochastic process step comprises a trained time-conditioned image-to-image neural network. An image-to-image neural network maps an input image, or more generally an input tensor, to an output image, or more generally an output tensor, that is a modified version of the input image or more generally of the input tensor. A tensor here refers to a matrix with two or three or four or even more dimensions. In particular, in case of a latent conditional stochastic process the reverse stochastic process step can comprise a trained time-conditioned image-to-image-neural network that maps an input tensor in latent space to an output tensor in latent space. The output image preserves some of the properties of the input image, e.g., the size of the input image or some of the contents of the input image, while the appearance of the output image changes compared to the input image. Image-to-image neural networks perform tasks such as style transfer, image restoration, denoising, noise estimation, deblurring, filtering, etc. A time-conditioned image-to-image neural network uses a time step as an additional input, e.g., a time step in the form of an integer value, for example from an interval [0, T], or in the form of a floating point value, for example in an interval [0,1]. Image-to-image neural networks are fast when performing their task, since during inference only a single forward pass of the image-to-image neural network is required in contrast to, e.g., iterative solvers in physical simulations. The image-to-image neural network does not necessarily have to be time-conditioned. Even without the time step as additional input, the neural network could learn to estimate the time step from the input.

Image-to-image neural networks can comprise encoder-decoder architectures, autoencoders or U-Nets. Encoder-decoder architectures contain an encoder that maps an input to a latent space and a decoder that maps from the latent space back to the input space. Usually, the latent space is of lower dimensionality than the input space. In this way, the input is compressed in latent space, thereby preserving only the most relevant information of the input and reducing the runtime due to the lower complexity of the input at the same time. An autoencoder is a specific encoder—decoder architecture that learns to recover the input from the latent space. U-Nets are encoder—decoder architectures comprising additional skip connections that directly connect layers from the encoder to layers of the decoder. In this way, details of the input are available to the decoder that would otherwise be removed due to the compression in latent space. Therefore, according to an example, the reverse stochastic process comprises an encoder—decoder architecture, e.g., an autoencoder. In particular, the reverse stochastic process step can comprise a U-Net.

The time-conditioned image-to-image neural network can be trained to perform a reverse stochastic process step for a given time step. In this way, a fast implementation of the conditional diffusion model with a small number of trainable parameters is achieved.

According to another example, one or more reverse stochastic process steps contain different image-to-image neural networks that are jointly trained to reverse the stochastic process. Thus, the output of an image-to-image neural network is the input of the following image-to-image neural network, and the input of the first image-to-image neural network of the sequence is the initial sample. In this way, a flexible implementation of the reverse stochastic process is achieved, since the image-to-image neural networks at different time steps can differ.

There are different ways to condition the conditional diffusion model on the representation of the design of the photolithography mask that are described in the following.

According to an example, the trained conditional diffusion model is conditioned on the representation of the design of the photolithography mask by using one or more cross-attention layers in the time-conditioned image-to-image neural network to process the representation of the design of the photolithography mask. Cross-attention layers transform their input into a new representation called attention-based representation by processing or paying attention to another data source, here the representation of the design of the photolithography mask. Using cross-attention layers allows for the output of the reverse stochastic process step to depend on a second source of information, here on the representation of the design of the photolithography mask. Furthermore, compared to CNNs, cross-attention layers are not limited to convolutions within local neighborhoods, but take into account large parts or the whole second source of information, i.e., large parts or the complete representation of the design of the photolithography mask. In addition, the weights of the cross-attention layers are not fixed after training, but depend on the second source of information, i.e., on the representation of the design of the photolithography mask. Thus, cross-attention layers are particularly flexible in taking into account a second source of information, yielding highly accurate aerial image generation results for a given representation of a design of a photolithography mask.

According to another example, the trained conditional diffusion model is conditioned on the representation of the design of the photolithography mask by using the representation of the design of the photolithography mask as additional input to the trained conditional diffusion model. For example, the representation of the design of the photolithography mask can be concatenated to the input of the conditional diffusion model. In another example, the representation of the design of the photolithography mask and the input of the conditional diffusion model are used as separate inputs. The representation of the design of the photolithography mask and/or the input of the conditional diffusion model can be transformed before being used as input, e.g., by use of a neural network such as a CNN.

According to a preferred embodiment of the invention, the trained conditional diffusion model is conditioned on one or more further information in addition to the representation of the design of the photolithography mask. The option of conditioning the conditional diffusion model on further information allows for a particularly accurate, flexible and versatile generation of aerial images corresponding to the representation of the design of the photolithography mask. The further information can, for example, comprise information on an aerial image acquisition process, information on the design of the photolithography mask, information on an acquired aerial image, etc. Using this information, a more accurate aerial image can be generated by the trained conditional diffusion model. Further information on an acquired aerial image can, for example, be used to indicate non-measurable properties of the aerial images to be generated, e.g., appearance properties of the acquired aerial image, for example a noise level, a grey value range or a color range, a contrast, a style, etc.

According to an aspect of the invention, the condition of the trained conditional diffusion model is indicated by use of images and/or text and/or parameters. The condition comprises the representation of the design of the photolithography mask and, optionally, further information. By using images, text and/or parameters, the condition can be indicated in a very simple, versatile and accurate way. In addition, condition of the trained conditional diffusion model can be indicated in a way that is most suitable for the information. Some information is more accurately represented by images, some by text and some by parameters. Thus, more accurate aerial images can be generated. In addition, the indication of the condition is simplified for the user.

A computer implemented method for training a conditional diffusion model for generating an aerial image of a photolithography mask in an image space according to any one of the preceding claims, the method comprising: obtaining training data comprising representations of one or more designs of one or more photolithography masks and one or more training images in the form of corresponding aerial images of the one or more photolithography masks; applying one or more stochastic process steps of the stochastic process of the conditional diffusion model to each of the training images, thereby generating transformed training images; training the conditional diffusion model to recover the training images from the transformed training images by carrying out iterations comprising: presenting one or more transformed training images to the conditional diffusion model that is conditioned on the corresponding representation of the design of the photolithography mask, thereby obtaining one or more outputs of the conditional diffusion model; modifying the parameters of the conditional diffusion model to optimize an objective function.

According to an example, the conditional diffusion model is a latent conditional diffusion model that operates in a latent space and that comprises a mapping from the image space to the latent space and a mapping from the latent space to the image space, and wherein the training images are mapped to the latent space in step a. of the computer implemented method for training a conditional diffusion model. By using latent conditional diffusion models, the runtime can be reduced, and only the most relevant information (features) is preserved in latent space, thereby improving the quality of the generated aerial images.

A computer implemented method for localizing defects in a photolithography mask according to an embodiment of the invention comprises: acquiring an aerial image of the photolithography mask; applying a computer implemented method for generating an aerial image of the photolithography mask in an image space according to an embodiment, example or aspect described above, wherein the acquired aerial image is used as representation of the design of the photolithography mask; and localizing defects by comparing the acquired aerial image to the generated aerial image.

A computer implemented method for aligning an aerial image of a photolithography mask to a representation of a design of the photolithography mask for use of the alignment in photolithography mask defect detection or repair according to an embodiment of the invention comprises: acquiring the aerial image of the photolithography mask in an image space; applying a computer implemented method for generating an aerial image of the photolithography mask according to an embodiment, example or aspect described above; and aligning the acquired aerial image and the generated aerial image by solving an optimization problem.

A computer implemented method for generating repair shapes for a photolithography mask according to an embodiment of the invention comprises: acquiring an aerial image of the photolithography mask; applying a computer implemented method for generating an aerial image of the photolithography mask in an image space according to an embodiment, example or aspect described above, wherein the acquired aerial image is used as representation of the design of the photolithography mask; comparing the acquired aerial image to the generated aerial image to derive repair shapes from the deviations, for use of the repair shapes for repairing the photolithography mask. Repair shapes indicate material that has to be added to or removed from the photolithography mask and are obtained by comparing the acquired aerial image to the generated aerial image.

A computer-readable medium according to an embodiment of the invention has stored thereon a computer program executable by a computing device, the computer program comprising code for executing a method according to any of the previously described embodiments, examples or aspects of the invention.

A computer program product according to an embodiment of the invention comprises instructions which, when the program is executed by a computer, cause the computer to carry out a method according to any of the previously described embodiments, examples or aspects of the invention.

A system for generating an aerial image of a photolithography mask according to an embodiment of the invention comprises: one or more processing devices; and one or more machine-readable hardware storage devices comprising instructions that are executable by one or more processing devices to apply a method for generating an aerial image of a photolithography mask according to an embodiment, example or aspect described above.

A system for localizing defects in a photolithography mask according to an embodiment of the invention comprises: a subsystem for acquiring an aerial image of the photolithography mask; and a data analysis device comprising at least one memory and at least one processor configured to perform the steps of the computer implemented method for localizing defects in a photolithography mask according to an embodiment, example or aspect described above.

A system for aligning an aerial image of a photolithography mask to a representation of a design of the photolithography mask for use of the alignment in photolithography mask defect detection or repair according to an embodiment of the invention comprises: a subsystem for acquiring an aerial image of the photolithography mask; and a data analysis device comprising at least one memory and at least one processor configured to perform the steps of the computer implemented method for aligning an aerial image of a photolithography mask to a representation of a design of the photolithography mask according to an embodiment, example or aspect described above.

A system for repairing a photolithography mask according to an embodiment of the invention comprises: a subsystem for acquiring an aerial image of the photolithography mask; a data analysis device comprising at least one memory and at least one processor configured to perform the steps of the computer implemented method for generating repair shapes for a photolithography mask according to an embodiment, example or aspect described above; and a repair system for repairing the photolithography mask that uses the generated repair shapes.

The invention described by examples and embodiments is not limited to the embodiments and examples but can be implemented by those skilled in the art by various combinations or modifications thereof.

### BRIEF DESCRIPTION OF THE DRAWINGS

FIG. 1 illustrates an exemplary transmission-based photolithography system, e.g., a deep ultraviolet (DUV) photolithography system.

FIG. 2 illustrates an exemplary reflection-based photolithography system, e.g., an extreme ultra-violet light (EUV) photolithography system;

FIG. 3 illustrates a flowchart of a computer implemented method for generating an aerial image of a photolithography mask;

FIGS. 4A-4F show different representations of designs of photolithography masks;

FIG. 5 illustrates a conditional diffusion model that is conditioned on a representation of a design of a photolithography mask;

FIG. 6 illustrates a latent conditional diffusion model that is conditioned on a representation of a design of a photolithography mask;

FIG. 7 illustrates a latent conditional diffusion model that is conditioned on a representation of a design of a photolithography mask by use of concatenation;

FIG. 8 illustrates a latent conditional diffusion model that is conditioned on a representation of a design of a photolithography mask by use of cross-attention layers;

FIG. 9 illustrates a cross-attention layer;

FIG. 10 illustrates a conditional diffusion model that is conditioned on a representation of a design of a photolithography mask and on further information;

FIG. 11 shows a comparison of an acquired aerial image and a generated aerial image of a photolithography mask using a method according to an embodiment of this invention;

FIG. 12 shows a flowchart of a computer implemented method for training a conditional diffusion model;

FIG. 13 shows a flowchart of a computer implemented method for defect localization in a photolithography mask;

FIG. 14 shows a flowchart of a computer implemented method for aligning an aerial image of a photolithography mask to a representation of a design of the photolithography mask;

FIG. 15 shows a flowchart of a computer implemented method for generating repair shapes for a photolithography mask;

FIG. 16 shows a flowchart of a computer implemented method for training a machine learning model for defect detection in photolithography masks;

FIG. 17 illustrates a system for generating an aerial image of a photolithography mask;

FIG. 18 illustrates a system for localizing defects in a photolithography mask;

FIG. 19 illustrates a system for repairing a photolithography mask; and

FIG. 20 illustrates a system for aligning an aerial image of a photolithography mask to a representation of a design of the photolithography mask.

### DETAILED DESCRIPTION

In the following, advantageous exemplary embodiments of the invention are described and schematically shown in the figures. Throughout the figures and the description, same reference numbers are used to describe same features or components. Dashed lines indicate optional features.

The methods and systems herein can be used with a variety of photolithography systems, e.g., transmission-based photolithography systems 10 or reflection-based photolithography systems 10′.

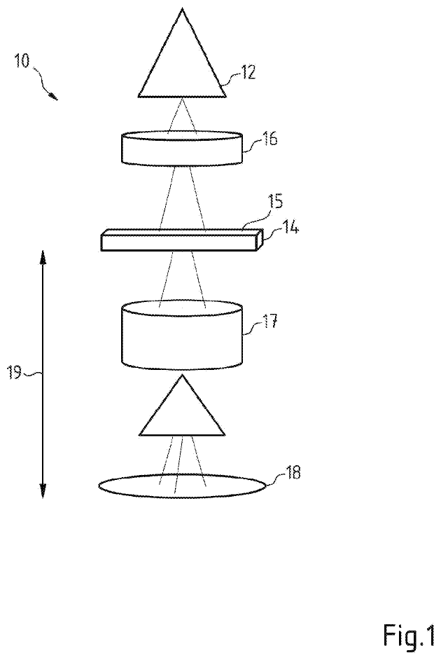

FIG. 1 illustrates an exemplary transmission-based photolithography system 10, e.g., a DUV photolithography system. Major components are a radiation source 12, which may be a deep-ultraviolet (DUV) excimer laser source, imaging optics which, for example, define the partial coherence and which may include optics that shape radiation from the radiation source 12, a photolithography mask 14, illumination optics 16 that illuminate the photolithography mask 14 and projection optics 17 that project an image of the photolithography mask pattern onto a wafer plane 18. An adjustable filter or aperture at the pupil plane of the projection optics 17 may restrict the range of beam angles that impinge on the wafer plane 18, where the largest possible angle defines the numerical aperture of the projection optics NA=n sin(Gmax), wherein n is the refractive index of the media between the substrate and the last element of the projection optics 17, and Gmax is the largest angle of the beam exiting from the projection optics 17 that can still impinge on the wafer plane 18. The photolithography mask 14 contains a base plane 15. In case of a transmission-based photolithography mask as shown in FIG. 1, the base plane 15 of the photolithography mask 14 is the plane of the photolithography mask 14, on which the incident electromagnetic waves impinge first.

In the present document, the terms “radiation” or “beam” are used to encompass all types of electromagnetic radiation, including ultraviolet radiation (e.g., with a wavelength of 365, 248, 193, 157 or 126 nm) and EUV (extreme ultra-violet radiation, e.g., having a wavelength in the range of about 3-100 nm).

Illumination optics 16 may include optical components for shaping, adjusting and/or projecting radiation from the radiation source 12 before the radiation passes the photolithography mask 14. Projection optics 17 may include optical components for shaping, adjusting and/or projecting the radiation after the radiation passes the photolithography mask 14. The illumination optics 16 exclude the light source 12, the projection optics exclude the photolithography mask 14.

Illumination optics 16 and projection optics 17 may comprise various types of optical systems, including refractive optics, reflective optics, apertures and catadioptric optics, for example. Illumination optics 16 and projection optics 17 may also include components operating according to any of these design types for directing, shaping or controlling the projection beam of radiation, collectively or singularly.

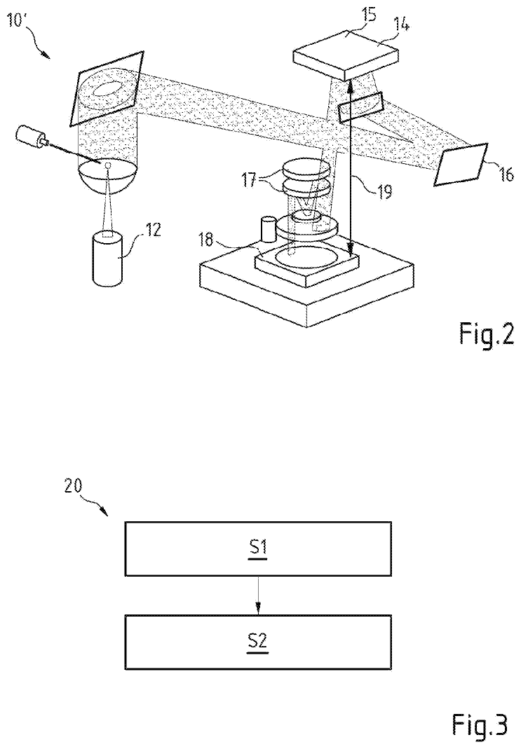

FIG. 2 illustrates an exemplary reflection-based photolithography system 10′, e.g., an extreme ultraviolet light (EUV) lithography system. Major components are a radiation source 12, which may be a laser plasma light source, illumination optics 16 which, for example, define the partial coherence and which may include optics that shape radiation from the radiation source 12, a photolithography mask 14, and projection optics 17 that project an image of the photolithography mask pattern 92 onto a wafer plane 18. An adjustable filter or aperture at the pupil plane of the projection optics 17 may restrict the range of beam angles that impinge on the wafer plane 18, where the largest possible angle defines the numerical aperture of the projection optics NA=n sin(Gmax), wherein n is the refractive index of the media between the substrate and the last element of the projection optics 17, and Gmax is the largest angle of the beam exiting from the projection optics 17 that can still impinge on the wafer plane 18. The photolithography mask 14 contains a base plane 15. In case of a reflection-based photolithography mask as shown in FIG. 1, the base plane 15 of the photolithography mask 14 is the plane of the photolithography mask 14 that is opposite to the plane, on which the incident electromagnetic waves impinge first. In an EUV lithography mask, the base plane is the ground plane of the multilayer.

As rigorous generations of the propagation of electromagnetic waves through photolithography masks such as finite difference time domain (FDTD) or rigorous coupled wave analysis (RCWA) are computationally too slow and approximations such as Kirchhoff's thin element approximation (TEA) are not sufficiently accurate, methods providing a fast and accurate generation of aerial images are required.

FIG. 3 illustrates a flowchart of a computer implemented method 20 for generating an aerial image of a photolithography mask in an image space. The method comprises: obtaining a representation of a design of the photolithography mask in a step S1; applying a trained conditional diffusion model that is configured to sequentially revert a stochastic process to an initial sample in order to generate an aerial image of the photolithography mask, wherein the trained conditional diffusion model is conditioned on the representation of the design of the photolithography mask in a step S2.

The representations 21 can, for example, be two-dimensional or three-dimensional or of higher dimensionality. The representations 21 can, for example, be obtained from a CAD file or some other model describing the structures on the photolithography mask. The representations 21 can, for example, comprise planes parallel to the base plane of the photolithography mask, or cross-sections of the photolithography mask, a 3D model of the photolithography mask, etc. The representations 21 can contain binary or grey value images describing different structures in different tones, or they can contain text describing the structures on the photolithography mask. The representations 21 can contain semantic information. The term “semantic information” refers to information describing properties of the structures on the photolithography mask, e.g., the type of structures, the material of structures, physical properties of the structures such as the refractive index, electric permittivity, magnetic permeability, etc., information describing the layers of the photolithography mask, e.g., the number of layers, the thickness of layers, the order of layers, etc. Semantic information can, for example, be encoded using different grey values in an image, different numbers or by using text, etc. The representations 21 can contain location information, e.g., the structures in the representation 21 can be placed according to their location on the photolithography mask. Alternatively, the representations 21 can contain approximate location information, e.g., in the form of bounding boxes of any shape and size, or in the form of rasterized images forming multiple sections that each contains information on the structures within the section. Alternatively, the representations 21 can contain no location information, e.g., representations 21 in the form of a list of text describing structures on the photolithography mask. The representations 21 can be mapped to another space, e.g., by applying a neural network such as a convolutional neural network, or some other kind of mapping function to a representation 21. The space can have less or more dimensions or the same number of dimensions.

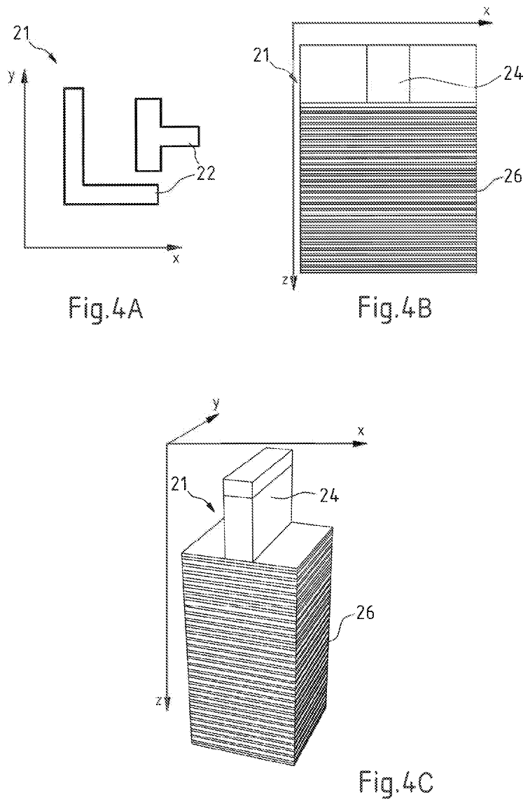

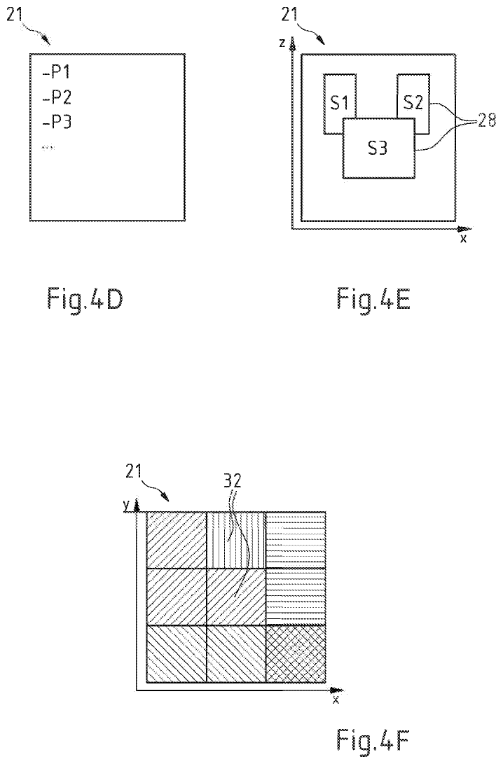

FIGS. 4A to 4F show different examples of representations 21 of designs of photolithography masks. The directions x and y in FIG. 4A to 4F describe horizontal directions parallel to the surface of the photolithography masks, whereas the z-direction describes the direction orthogonal to the base plane 15 of the photolithography mask 14. FIG. 4A shows a 2D binary representation 21 containing structures 22, e.g., polygons, in an x/y plane, e.g., on the surface or in some layer of the photolithography mask, obtained from a CAD file. FIG. 4B shows a cross section image of a photolithography mask, i.e., a plane in x/z direction. The photolithography mask is an EUV photolithography mask containing absorber structures 24 and a multilayer 26 in the form of a stack of optical thin films for reflecting the incident electromagnetic waves. The representation 21 in the form of an image can, for example, indicate different materials or physical properties of the structures in the photolithography mask by different grey values, colors or parameters. FIG. 4C shows a 3D representation 21 of a design of an EUV photolithography mask containing absorber structures 24 and a multilayer 26. The representation 21 in the form of a 3D image or volume can, for example, indicate different materials or physical properties of the structures in the photolithography mask by different grey values, colors or parameters. The representation 21 of the design of the photolithography mask in FIG. 4D is given in form of a text description. The text describes, for example, the position or layout of polygons in a design of the photolithography mask that can be obtained, e.g., from a CAD file or other model. FIGS. 4E and 4F illustrate a representation 21 of a design of a photolithography mask using approximate location information. FIG. 4E, for example, contains three bounding boxes 28 indicating the approximate location of structures, e.g., structure 1 is contained within bounding box S1, structure 2 within bounding box S2 and structure 3 within bounding box S3. FIG. 4F shows a rasterized image 30 containing in each section 32 information about the structures contained in the corresponding section of the photolithography mask. Furthermore, a representation 21 of a design of a photolithography mask not shown in FIG. 4 can contain only a single vector that indicates the materials along the z-direction of the photolithography mask perpendicular to the base plane 15 of the photolithography mask.

According to an aspect of the invention, the representation 21 of the design of the photolithography mask describes the photolithography mask at least partially in a dimension orthogonal to the base plane 15 of the photolithography mask 14. Thus, the representation 21 of the design of the photolithography mask is not limited to a thin mask image that disregards the dimension orthogonal to the base plane 15. Instead, the representation 21 contains information in z-direction of the photolithography mask and, thus, about the internal structure of the photolithography mask. In this way, mask 3D effects can be prevented as the vertical dimension of the structures on the photolithography mask is taken into account.

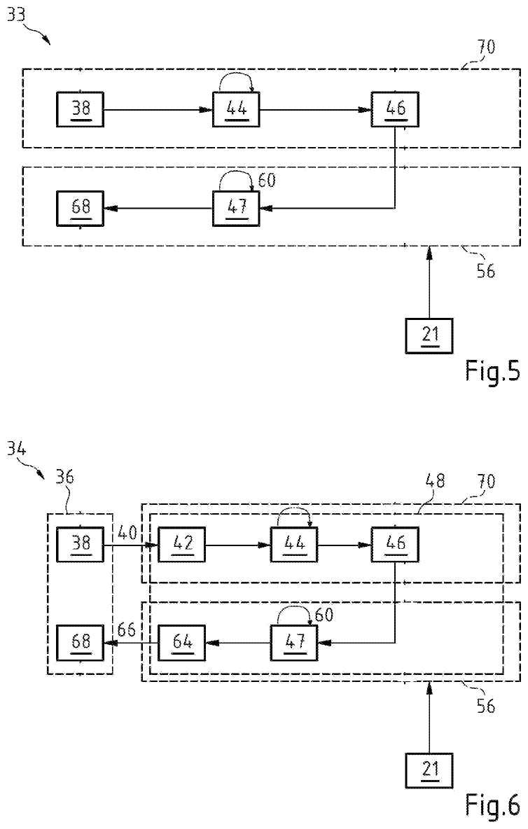

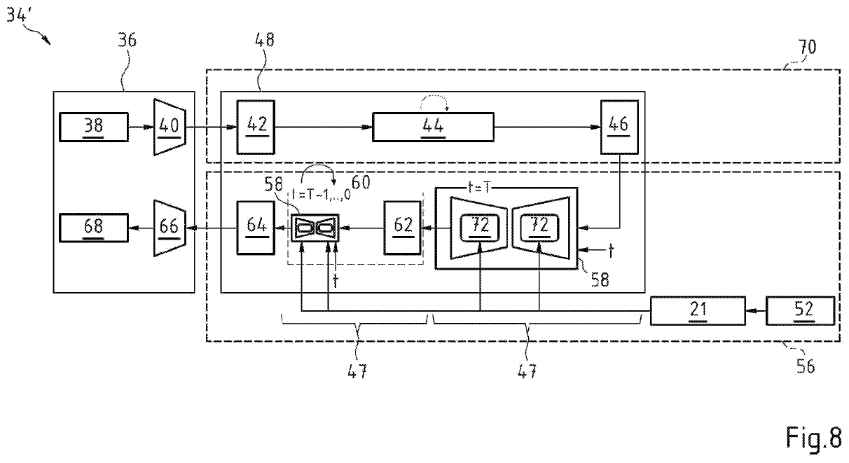

In order to obtain highly accurate generated aerial images from representations 21 of designs of photolithography masks, conditional diffusion models 33 can be used as shown in FIG. 5. Conditional diffusion models 33 can comprise deep generative machine learning models. During training, they apply one or more stochastic process steps 44 to aerial images 38. This is known as the stochastic process 70, which is used during training of the conditional diffusion model 33. The stochastic process 70 gradually results in transformed samples 46 that are farther from the learned manifold, e.g., “more random”. The stochastic process 70 is then reversed in a reverse stochastic process 56 to recover the original aerial images 38 by iteratively applying a reverse stochastic process step 47 yielding generated aerial images 68. In this way, the model learns to gradually remove the effect of the stochastic process 70 from the transformed samples 46. During inference, only the reverse stochastic process 56 is applied to randomly generated initial samples 46 to generate high-quality aerial images 68. Since the invention does not aim at generating arbitrary aerial images 68, but aerial images 68 for a specific photolithography mask, the diffusion model according to this invention is a conditional diffusion model that is conditioned on the representation 21 of the design of the photolithography mask. This is accomplished by using the representation 21 of the design of the photolithography mask as input to the reverse stochastic process 56. There are different ways of using this conditional information that will be described with respect to FIGS. 7 and 8 below.

Each conditional diffusion model is configured to revert a stochastic process 70. The stochastic process 70 is applied to an aerial image 38 by sequentially applying a stochastic process step 44, thereby obtaining a transformed sample 46. In a reverse stochastic process 56 a reverse stochastic process step 47 is sequentially applied to the initial sample 46, thereby recovering the aerial image. During training, acquired aerial images are used as training images, and the reverse stochastic process step 47 is learned during training in order to reduce the deviation of the acquired aerial images and the output of the conditional diffusion model 33. During inference, an initial sample 46, e.g., a random initial sample, is generated, and only the reverse stochastic process 56 is applied to the initial sample 46. The conditional diffusion model is conditioned on a representation 21 of the design of the photolithography mask. In this way, an aerial image is generated for a photolithography mask with a design indicated by the representation 21 of the design of the photolithography mask.

According to an aspect of the invention, the stochastic process is from the group comprising noising, blurring, masking, pixelation, morphing, filtering. The term “noising” means to add any kind of noise to the aerial image, e.g., Gaussian noise, salt and pepper noise, shot noise, pattern noise, etc. Adding pattern noise to an image means that the integrated circuit patterns are slightly disrupted, e.g., by increasing the line edge roughness or by making slight modifications to the integrated circuit patterns. The term “blurring” means to blur the aerial image or reduce the sharpness of the aerial image, the term “masking” means to mask one or more parts of the aerial image, the term “pixelation” means to replace the values of groups of pixels by a single average value, thereby generating the impression of a reduced resolution, the term “morphing” means to morph the aerial image into another image, the term “filtering” means to apply some kind of filtering operation to the aerial image, wherein the filter size can be selected randomly.

In an example, the stochastic process is from the group consisting of noising, blurring, masking, pixelation, morphing, filtering. In a preferred embodiment the stochastic process is a noising process.

In an example, the trained conditional diffusion model 33 is applied to an initial sample 46 that depends on the stochastic process 70 of the trained conditional diffusion model 33. Preferably, the initial sample 46 is of the target size of the aerial image 68 to be generated by the conditional diffusion model. For example, in case the stochastic process 70 is a noising process, the initial sample 46 is a noise image, e.g., a Gaussian noise image. For example, in case the stochastic process 70 is a blurring process, the initial sample 46 is a fully blurred image, e.g., containing only a single value. For example, in case the stochastic process 70 is a masking process, the initial sample 46 is a fully masked image, e.g., containing a single value such as 0. For example, in case the stochastic process 70 is a pixelation process, the initial sample 46 contains only a single value. For example, in case the stochastic process 70 is a morphing process, the initial sample 46 contains the image that is morphed with the aerial image during the morphing process. For example, in case the stochastic process is a filtering process, the initial sample 46 depends on the type of filter.

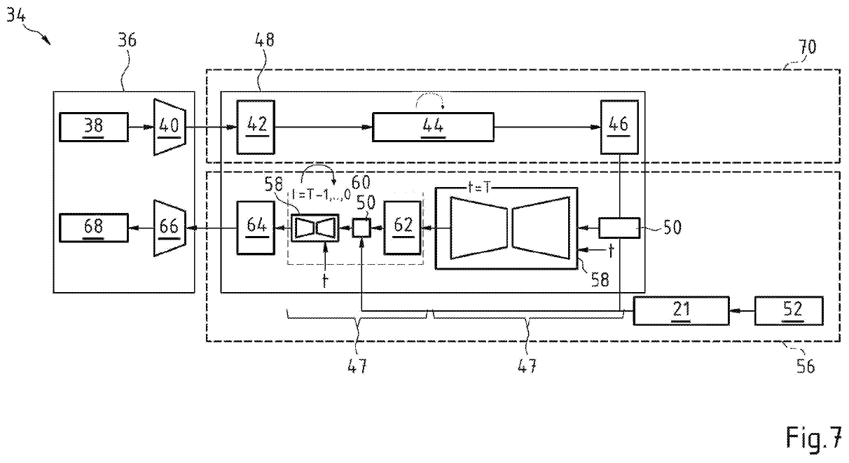

According to a preferred embodiment of the invention as illustrated in FIG. 6, the trained conditional diffusion model 33 is a trained latent conditional diffusion model 34 that operates in a latent space 48 of the image space 36 and that comprises a mapping 40 from the image space 36 to the latent space 48 and a mapping 66 from the latent space 48 to the image space 36. The trained latent conditional diffusion model 34 maps an initial sample 46 in a latent space 48 to a latent representation 64 of an aerial image 68 in the latent space 48 by iteratively applying a reverse stochastic process step 47, and it maps the latent representation 64 of the aerial image 68 in the latent space 48 to the generated aerial image 68 in the image space 36. The mapping from the image space 36 to the latent space 48 and back from the latent space 48 to the image space 36 can, for example, be carried out by a pair of a trained encoder and a decoder, e.g., an autoencoder. The encoder as a mapping 40 maps an aerial image 38 in image space 36 to a latent representation 42 of the aerial image 38 in latent space 48, and the decoder as a mapping 66 maps the latent representation 64 of a generated aerial image 68 in the latent space 48 to the aerial image 68 in image space 36. The use of a latent conditional diffusion model 34 is advantageous, since the information in the image space 36 is compressed in the latent space 48. Thus, the compressed information in latent space 48 is less complex and contains only the most relevant information. For this reason, the latent conditional diffusion model 34 is very fast to apply and very accurate since it concentrates on the most relevant information contained in the input data in image space 36.

According to an example, the trained latent conditional diffusion model 34 is conditioned on a representation 21 of the design of the photolithography mask in latent space 48, and the representation 21 of the design of the photolithography mask in latent space 48 is obtained by applying a trained neural network, in particular a convolutional neural network, to the representation 21 of the design of the photolithography mask. In this way, the design of the photolithography mask can, for example, also be mapped to the latent space 48 or to some other space that is particularly suitable for conditioning the conditional diffusion model 33.

In order to improve the results of the conditional diffusion model, the conditional diffusion model can be applied two or more times to different initial samples. The results can be statistically processed, e.g., by computing the mean of the results and using the variance of the results as an uncertainty measure.

In the following, the conditional diffusion model 33 can be a latent conditional diffusion model 34 as shown in FIGS. 6 and 7, but the invention is not limited to latent conditional diffusion models but also relates to conditional diffusion models. In conditional diffusion models, the stochastic process 70 and the reverse stochastic process 56 are carried out in image space 36 without mapping 40, 66 to a latent space 48 and back.

According to a preferred embodiment illustrated with respect to latent conditional diffusion models 34, 34′ in FIGS. 7 and 8, sequentially reversing the stochastic process 70 comprises applying a learned reverse stochastic process step 47 to the initial sample 46 in a first time step and to the result of the respective previous reverse stochastic process step 47 in all following time steps, wherein the learned reverse stochastic process step 47 reverses a time step of the stochastic process 70. The time steps can also be called refinement steps or diffusion steps or iterations. Preferably, at least two time steps, more preferably at least 5 time steps, most preferably at least 10 time steps are used. Usually between 10 and 1000, preferably between 20 and 300 time steps, more preferably between 25 and 200 time steps, most preferably between 50 and 100 time steps are carried out. Using speed up techniques during inference, even between 5 and 10 time steps can be sufficient.

The time step t=T, . . . ,0 can be used as additional input to the reverse stochastic process step 47. The time step t can, for example, be encoded using a positional embedding similar to the positional encodings in Transformer architectures. In the first time step t=T the reverse stochastic process step 47 is applied to the initial sample 46, whereas in the further time steps t=T−1, . . . ,0 the reverse stochastic process step 47 is applied to the result of the respective previous reverse stochastic process step 47. By using the time step t as input, only a single reverse stochastic process step needs to be learned and implemented. For example, in case the stochastic process is a noising process, a single denoising step can be trained to reverse the noising process by sequentially applying the denoising step to the initial sample 46. Instead of applying the reverse stochastic process step 47 for each single time step corresponding to a standard Markovian assumption, two or more reverse stochastic process steps can be carried out simultaneously. For example, in case of a noising process, the noise for n repeated reverse stochastic process steps can be statistically predicted (e.g., by applying n Gaussian processes) and the resulting noise image can be directly subtracted from the input image, thereby applying n reverse stochastic process steps simultaneously.

There are different ways of implementing a reverse stochastic process step 47. For example, the reverse stochastic process step 47 can directly revert a time step of the stochastic process, e.g., in case of a noising process, the image can be mapped to a less noisy image. In another example, the reverse stochastic process step 47 can estimate the effect of the stochastic process step, i.e., the difference between the image and a reverse-transformed version of the image, and subsequently remove the difference from the image. The reverse stochastic process step 47 can also directly predict a corresponding image of the learned manifold. The predicted image of the manifold can be used to modify the current image with a change towards the predicted image of the manifold, or the predicted image of the manifold can be subsequently modified by applying multiple time steps of the stochastic process. The reverse stochastic process step 47 can also predict the difference between the image and a corresponding image of the learned manifold. The difference can then be scaled and subtracted from the, optionally scaled, image in the reverse stochastic process step. Optionally, the reverse stochastic process step can further comprise adding an additional scaled random sample, e.g., a scaled Gaussian i.i.d. (independent and identically distributed) noise sample, to the reverse-transformed image.

In another example, the trained conditional diffusion model 33 contains a sequence 60 of (potentially different) reverse stochastic process steps 47 that are jointly trained to reverse the stochastic process 70. The output of a reverse stochastic process step 47 is the input of the following reverse stochastic process step 47, and the input of the first reverse stochastic process step 47 of the sequence 60 is an initial sample 46. In case the stochastic process 70 is a noising process, the reverse stochastic process step 47 of the trained conditional diffusion model 33 is implemented as a sequence 60 of reverse stochastic process steps 47 in the form of denoising steps that each is trained to map the output of the previous denoising step to a less noisy version thereof, and wherein the initial sample is a noise sample, e.g., containing Gaussian noise. The denoising steps can be different, or they can be identical. By using a sequence of reverse stochastic process steps 47 that each reverses a time step of the stochastic process 70 the model learns to correct itself.

In an example, the learned reverse stochastic process step 47 comprises a trained time-conditioned image-to-image neural network 58. An image-to-image neural network is a neural network that learns a mapping from an input image, or an input tensor, to an output image, or an output tensor. Thus, the input and the output of the neural network are images, or tensors, e.g., in case of latent diffusion models. Image-to-image neural networks comprise, for example, encoder-decoder neural networks, U-Nets and autoencoders. The image-to-image neural network can, optionally, comprise quantization operations.

The time-conditioned image-to-image neural network 58 can be trained to perform a reverse stochastic process step 47 for a given time step. The time-conditioned image-to-image neural network 58 can alternatively be trained to predict the difference between the image and a reverse-transformed version of the image, e.g., the noise. The difference is then subtracted from the image in the reverse stochastic process step 47. The time-conditioned image-to-image neural network 58 can be trained to predict the difference between the image and a corresponding image of the learned manifold. The difference is then scaled and subtracted from the, optionally scaled, image in the reverse stochastic process step 47. The time-conditioned image-to-image neural network 58 can also be trained to directly predict a corresponding image of the learned manifold. Due to the inaccuracy of a direct prediction, the prediction can be used to modify the image in a direction towards the manifold. The reverse stochastic process step 47 can, for example, take only a small step towards the predicted image of the learned manifold, e.g., by computing a convex combination of the image and the predicted image. Alternatively, the reverse stochastic process step 47 can take the predicted image of the manifold and subsequently apply the stochastic process (e.g., the noising process) multiple times, e.g., t−1 times at a given time step t, to obtain a reverse-transformed version of the image that is only a small step closer to the manifold. Optionally, the reverse stochastic process step 47 can further comprise adding an additional scaled random sample, e.g., a scaled Gaussian i.i.d. noise sample, to the reverse-transformed image.

In case of a latent conditional diffusion model as shown in FIG. 7, a latent representation 64 of the aerial image 68 is recovered in the reverse stochastic process 56, which is mapped to the aerial image 68 in image space 36, e.g., by use of a decoder.

The conditional diffusion model, in particular the latent conditional diffusion model 34, 34′, can be conditioned on the representation 21 of the design of the photolithography mask in different ways. In FIG. 7, the trained conditional diffusion model is conditioned on the representation 21 of the design of the photolithography mask by using the representation 21 of the design of the photolithography mask as additional input to the trained conditional diffusion model, in particular, to the reverse stochastic process 56, more particular to the reverse stochastic process step 47. For example, the representation 21 of the design of the photolithography mask can be concatenated 50 to the transformed sample 46 as shown in FIG. 7. In another example, the representation 21 of the design of the photolithography mask and the transformed sample 46 are processed as separate inputs of the trained conditional diffusion model. The representation 21 of the design of the photolithography mask can, for example, be obtained from a CAD-file 52.

In FIG. 8, the trained conditional diffusion model 33, in particular the latent conditional diffusion model 34, 34′, is conditioned on the representation 21 of the design of the photolithography mask by using one or more cross-attention layers 72 in the time-conditioned image-to-image neural network 58 to process the representation 21 of the design of the photolithography mask. The representation 21 of the design of the photolithography mask can, for example, be obtained from a CAD-file 52.

Cross-attention layers 72 transform their input into a new representation called attention-based representation by processing or paying attention to another data source such as the representation 21 of the design of the photolithography mask.

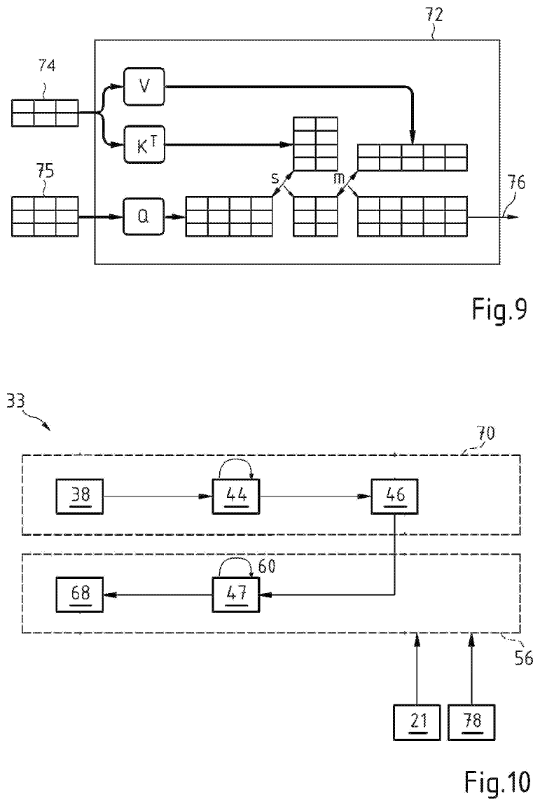

A possible realization of a cross-attention layer 72 as illustrated in FIG. 9 can be described as follows: let T⊂ [symbol] ^{D}^{_{T}} denote a first set of tokens 74 represented by multivariate feature vectors of dimensionality D_{T}, each token 74 representing a portion of the input of the cross-attention layer 72. Let U⊂ [symbol] ^{D}^{_{U}} denote a second set of tokens 75 represented by multivariate feature vectors, each token 75 representing a portion of the representation 21 of the design of the photolithography mask. The cross-attention layer 72 represents a mapping a: [symbol] ^{D}^{_{T}}→ [symbol] ^{\hat{D}} that transforms the first set of tokens 74 into cross-attention based representations 76 by taking into account the second set of tokens 75 (the representation 21 of the design of the photolithography mask). The mapping a uses a similarity function s: [symbol] ^{D}^{ₖ}× [symbol] ^{D}^{ₖ}→ [symbol] and an aggregation function m: [symbol] ( [symbol] ^{D}^{ᵥ})→ [symbol] ^{\hat{D}}

$$a ( t ) = m ( \{ s ( q ( t ) , k ( u ) ) \cdot v ( u ) \vert u ∈ U \} )$$

[symbol]

denotes the power set. The functions k: [symbol] ^{D}^{_{U}}→ [symbol] ^{D}^{ₖ}, q: [symbol] ^{D}^{_{T}}→ [symbol] ^{D}^{ₖ}, and v: [symbol] ^{D}^{_{U}}→ [symbol] ^{D}^{ᵥ} are local feature transformations called query, key and value function that map a token t to a so-called query, key and value. The query, key and value function can, for example, comprise a trainable parameter, e.g., one or more projection matrices Q, K and V shown in FIG. 9. The comparison function s measures the similarity between the query q(t) for each token t of the first set of tokens 74 and the key k(u) for all tokens u∈U of the second set of tokens 75. Thus, similarities between the first set of tokens 74 (the input of the cross-attention layer 72) and the second set of tokens 75 (the representation 21 of the design of the photolithography mask) are measured by the function s. The value v(u) can be understood as a representation of the token u. The aggregation function m, thus, aggregates all values of the tokens v(u) of the second set of tokens 75 weighted by their similarity to the query q(t) of the first set of tokens 74. Thus, instead of using fixed values as weights as in case of convolutions, the weights depend on the similarity of the first and second set of tokens 74, 75.

An example for a cross-attention layer 72 called “scaled dot-product attention” or “softmax attention” defines the similarity function and the aggregation function as follows:

$$s ( t , u ) = \frac{exp ( 〈 t , u 〉 / \sqrt{{d}_{k}} )}{{\sum }_{{u}^{′} ∈ T} exp ( 〈 t , {u}^{′} 〉 / \sqrt{{d}_{k}} )} , m ( X ) = {\sum }_{x ∈ X} x .$$

In this implementation, the functions k, q, v are typically realized by a learned linear transformation (projection matrices) or a small multilayer perceptron. Further attention mechanisms can also be used, e.g., “additive attention” or “not-scaled dot-product attention.” The aforementioned attention mechanisms are described in “Attention is all you need, A. Vaswani, N. Shazeer, N. Parmar, J. Uszkoreit, L. Jones, A. Gomez, L. Kaiser, I. Polosukhin, Advances in Neural Information Processing Systems, vol. 30. 2017.”

Using cross-attention layers 72 has the following advantages: first, the cross-attention based representations 76 take into account relationships between tokens from the first set of tokens 74 and many or all of the tokens from the second set of tokens 75 instead of only from a local neighborhood as, for example, in a CNN. Second, the processing operations are token-dependent instead of being fixed as, for example, in convolutions of CNNs. Thus, cross-attention layers 72 offer an accurate way of conditioning the conditional diffusion model on the representation 21 of the design of the photolithography mask.

According to a preferred embodiment of the invention illustrated in FIG. 10, the trained conditional diffusion model 33, in particular a latent conditional diffusion model 34, 34′, is conditioned on further information 78 in addition to the representation 21 of the design of the photolithography mask. The conditioning on one or more further information 78 can be implemented in different ways. For example, the one or more further information 78 can be concatenated to the representation 21 of the design of the photolithography mask. Thus, the conditional diffusion model is conditioned on a combination of the representation 21 of the design of the photolithography mask and one or more further information 78. In another example, the representation 21 of the design of the photolithography mask and the further information 78 are processed as separate inputs the conditional diffusion model 33 is conditioned on.

The further information 78 can, for example, comprise information on an aerial image acquisition process, e.g., a photon count, a defocus, an acquisition time, type or properties of the illumination, noise statistics, a noise type, aberration, pixel-size on sensor, apodization, dark current, stray light, stage blur, line edge roughness, and further optical parameters. The further information 78 can comprise information on the design of the photolithography mask, for example, the type of integrated circuit patterns, e.g., lines and spaces, pillars, memory patterns, logical patterns, etc. The further information 78 can comprise information on the structure of the photolithography mask, e.g., on the materials within the photolithography mask. The further information 78 can also comprise information on the aerial image to be generated, e.g., on the contents of the aerial image or on properties of the aerial image, e.g., the quality of the aerial image, the size of the aerial image, the appearance of the aerial image, etc. The further information can comprise information on an acquired aerial image, e.g., on the appearance of the aerial image or on further properties of the acquired aerial image. In this way, the appearance of an acquired aerial image that is examined for defects can be used to condition the generation of an aerial image using the methods described above. In this way, the generated aerial image is of the same or a similar appearance as the examined aerial image. Thus, defects can be detected more easily and accurately.

There are various ways to indicate the representation of a design of the photolithography mask and/or of the further information 78 that is used to condition the conditional diffusion model 33. In an example, the condition of the trained conditional diffusion model is indicated by use of images and/or text and/or parameters. Thus, the representation of the design of the photolithography mask and/or the further information is indicated by use of images and/or text and/or parameters. For example, the type of design can be described using text, e.g., “memory,” “logical,” “lines and spaces,” “circles,” etc. The images can, for example, be binary, grey-valued or color images. They can be 1D, 2D or 3D images. The images can, for example, comprise features or semantic information. The text can contain a description of properties of features, a description of the photolithography mask, a description of potential defects, a description of the appearance of the aerial image, a description of material properties, etc. The parameters can be numeric values, e.g., single values or vectors, for example, defocus values, misalignment values, etc., or they can be textual parameters, e.g., material parameters, etc.

For example, the further information 78 can comprise regions that indicate the presence of a specific defect within the region. The further information 78 can comprise regions that indicate the absence of defects, or regions that are of no interest. The regions can, for example, be indicated in an image or by use of coordinates in a text. The further information 78 can, for example, comprise a defocus value for the generated aerial image. The further information 78 can, for example, comprise material information for the photolithography mask. The further information 78 can, for example, contain the type of pattern in the design, e.g., memory or logical. Using this further information 78, the conditional diffusion model can be trained to generate images corresponding to this further information 78.

In an example, the conditional diffusion model 33 is conditioned on a concatenation of a representation 21 of the design of the photolithography mask such as a 3D image containing material parameters of the photolithography mask and further information 78 comprising the type of pattern in the design, e.g., the text “memory”, and further information 78 on a desired appearance of the generated aerial image that can be indicated by use of an acquired aerial image. In this way, the conditional diffusion model 33 generates aerial images corresponding to the material distribution in the design of the photolithography mask, containing memory structures and resembling the appearance of the acquired aerial image. The possibility of indicating further information 78 is what makes conditional diffusion models especially interesting for generating aerial images.

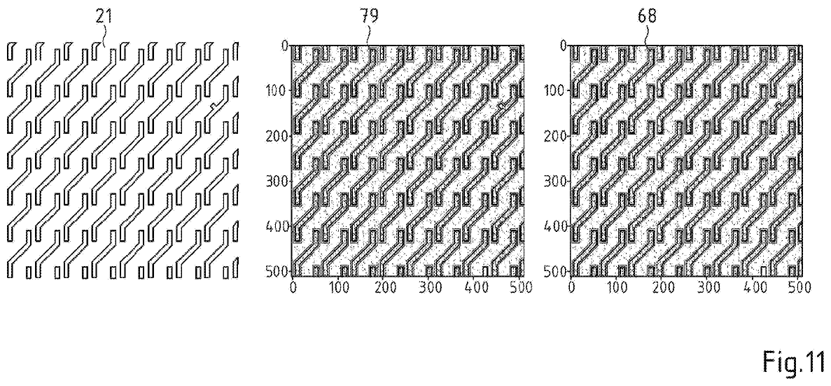

FIG. 11 shows a comparison of an acquired aerial image 79 (center) and a generated aerial image 68 of a photolithography mask using a method according to an embodiment of this invention (right). The conditional diffusion model is conditioned on a representation 21 of the design of the photolithography mask shown (left). The deviations of the generated aerial image 68 from the acquired aerial image 79 are close to 0. The generated aerial image 68 was obtained using time-conditioned image-to-image diffusion models from the Palette repository indicated in the paper “Palette: Image-to-Image Diffusion Models, C. Saharia, W. Chan, H. Chang, C. Lee, J. Ho, T. Salimans, D. Fleet, M. Norouzi, https://arxiv.org/abs/2111.05826.” The representation of the design and the output image were single channel 8 bit grey value images. During training, random crops of size 224 px×224 px were used. During inference, a resolution of 512 px×512 px was used. The following normalization was used: grey value/255−0.5. The diffusion model was trained on an EUV dataset containing thousands of simulated aerial images using the standard parameters of the Palette repository.

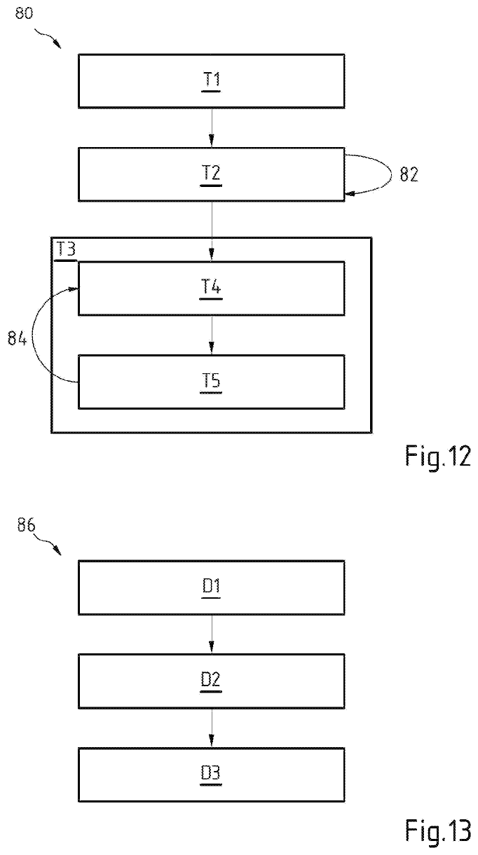

Referring to FIG. 12, a computer implemented method 80 for training a conditional diffusion model for generating an aerial image of a photolithography mask in an image space according to any one of the preceding claims, the method comprises: obtaining training data comprising representations of one or more designs of one or more photolithography masks and one or more training images in the form of corresponding aerial images of the one or more photolithography masks in a step T1; applying one or more stochastic process steps of the stochastic process of the conditional diffusion model to each of the training images, thereby generating transformed training images in a step T2; training the conditional diffusion model to recover the training images from the transformed training images in a step T3 by carrying out iterations comprising: presenting one or more transformed training images to the conditional diffusion model that is conditioned on the corresponding representation of the design of the photolithography mask, thereby obtaining one or more outputs of the conditional diffusion model in a step T4; and modifying the parameters of the conditional diffusion model to optimize an objective function in a step T5.

In step T1, the training data preferably comprises representations of multiple designs of multiple photolithography masks and corresponding aerial images. Due to the large size of a single photolithography mask, the training data can also comprise a representation of a single design of a single photolithography mask and the corresponding aerial image, or multiple crops of a representation of a single design of a single photolithography mask and corresponding crops of the corresponding aerial image. The corresponding aerial images can, for example, comprise acquired aerial images or simulated aerial images.

In step T2, different numbers 0≤t≤T of time steps of the stochastic process are applied to the training images. Thus, the conditional diffusion model simultaneously learns to revert the stochastic process for various time steps during training.

In case of more than one stochastic process steps, these stochastic process steps can be applied explicitly in an iterative manner. In some cases, multiple or all stochastic process steps can be applied implicitly within a single step to reduce computation time, e.g., in case of a noising stochastic process and normally distributed noise, multiple stochastic process steps can be computed directly in a single step.

The stochastic process steps can have the same or different properties. For example, in the case of a noising process, the bandwidths of the i.i.d. noise that is added in each stochastic process step can be identical for all steps, but they can also be different. For example, the bandwidths can be very small for the first stochastic process steps and increase for later stochastic process steps.

The objective function or loss function L in step T5 can be configured in various ways. For example, the objective function can contain the deviation of the training image x₀ from the output of the time-conditioned image-to-image neural network f(xₜ,t), where xₜ indicates the training image x₀ after applying t stochastic process steps:

$$L ( {x}_{0} , f ( {x}_{t} , t ) ) .$$

Another example for an objective function contains a measure for the quality of a single reverse stochastic process step applied to xₜ:

$$L ( {x}_{t - 1} , f ( {x}_{t} , t ) ) .$$

In case the reverse stochastic process step comprises a prediction pₜ¹ of the difference of the image and the reverse-transformed version of the image, e.g., a noise estimate for a single reverse stochastic process step, such that f(xₜ,t)=xₜ−pₜ¹, another example for an objective function could contain

$$L ( {x}_{t} - {x}_{t - 1} , {p}_{t}^{1} ) .$$

Instead of a single step, the modification for t steps pₜ^{t}, e.g., a noise estimate for t reverse stochastic process steps, could be evaluated using the following objective function

$$L ( {x}_{t} - {x}_{0} {p}_{t}^{t} ) .$$

In particular, a scaled estimate of the modification can be used as, for example, in the paper “Denoising Diffusion Probabilistic Models, J. Ho, A. Jain, P. Abbeel, 2020, arXiv 2006.11239, step 5 of algorithm 1.”

As before, the conditional diffusion model 33 that is trained using this method can be a latent conditional diffusion model 34 that maps a transformed sample 46 in a latent space 48 to a representation 64 of an aerial image 68 in the latent space 48, and that maps the representation 64 of the aerial image 68 in the latent space 48 to the aerial image 68.

Usually, an encoder is trained for mapping to the latent space and a decoder for mapping back from the latent space. The encoder and decoder can be trained before training the reverse stochastic process step of the latent conditional diffusion model. Often, the encoder and decoder form an auto-encoder. To this end, the loss function can comprise an adversarial loss at patch level in addition to a reconstruction loss. In this way, image-relevant high-level details are preserved by the decoder.

In order to regularize the latent space, a Kullback-Leibler loss (similar to variational autoencoders) can be used on the latent codes. Alternatively, the auto-encoder can contain a vector quantization (VQ)-layer for the latent-space such that the latent space is discrete instead of continuous. In this case, a loss based on distances between encoded vectors before quantization and associated embedding vectors can be used.

Subsequently, the reverse stochastic process step is learned in the latent space.

A computer implemented method 86 for localizing defects in a photolithography mask according to an embodiment of the invention illustrated in FIG. 13 comprises: acquiring an aerial image of the photolithography mask in a step D1; applying a computer implemented method for generating an aerial image of the photolithography mask in an image space according to any one of the embodiments, aspects or examples described above, wherein the acquired aerial image is used as representation of the design of the photolithography mask in a step D2; and localizing defects by comparing the acquired aerial image to the generated aerial image in a step D3.

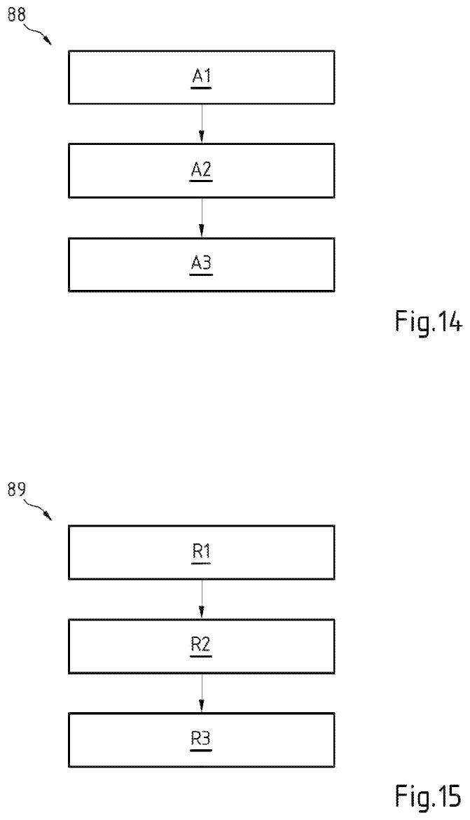

A computer implemented method 88 for aligning an aerial image of a photolithography mask to a representation of a design of the photolithography mask for use of the alignment in photolithography mask defect detection or repair according to an embodiment of the invention illustrated in FIG. 14 comprises: acquiring the aerial image of the photolithography mask in a step A1; applying a computer implemented method for generating an aerial image of the photolithography mask in an image space according to any one of the embodiments, aspects or examples described above in a step A2; and aligning the acquired aerial image and the generated aerial image by solving an optimization problem in a step A3. The optimization problem can solve a registration problem in order to register the acquired aerial image and the generated aerial image. The optimization problem can minimize an objective function using various optimization techniques such as gradient descent, simplex methods, primal-dual methods, PDE based methods, etc. The alignment of an aerial image of a photolithography mask and a representation of a design of the photolithography mask can be used as a first step for defect localization, or as a first step for generating repair shapes, as both defect localization and the generation of repair shapes benefit from an alignment for obtaining highly accurate results.

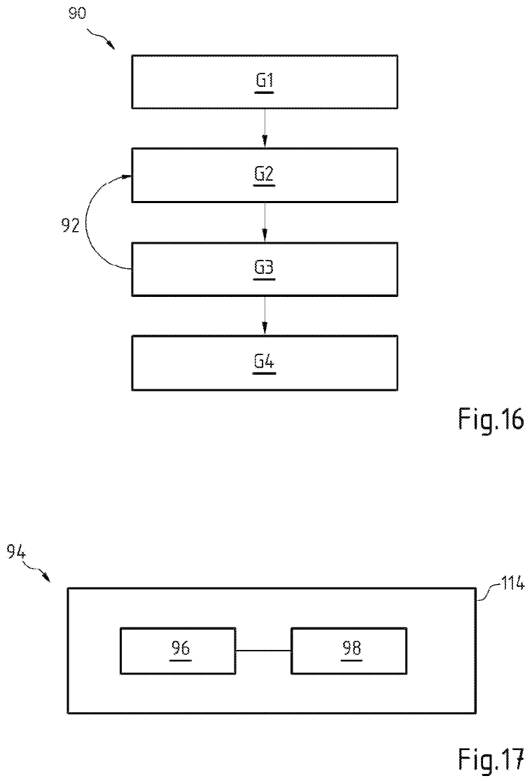

A computer implemented method 89 for generating repair shapes for a photolithography mask according to an embodiment of the invention illustrated in FIG. 15 comprises: acquiring an aerial image of the photolithography mask in a step R1; applying a computer implemented method for generating an aerial image of the photolithography mask in an image space according to any one of the embodiments, aspects or examples described above, wherein the acquired aerial image is used as representation of the design of the photolithography mask in a step R2; and comparing the acquired aerial image to the generated aerial image to derive repair shapes from the deviations in a step R3, for use of the repair shapes for repairing the photolithography mask. The repair shapes can be used for indicating missing material or excessive material that can be corrected using a repair system.

A computer implemented method 90 for training a machine learning model for defect detection in photolithography masks according to an embodiment of the invention illustrated in FIG. 16 comprises: obtaining representations of designs of photolithography masks in a step G1; iteratively 92 carrying out the following steps: selecting a representation of a design of a photolithography mask and one or more predefined defects in a step G2; applying a computer implemented method for generating an aerial image of a photolithography mask in an image space according to any one of the preceding embodiments, aspects or examples, wherein the trained conditional diffusion model is conditioned on the selected representation of the design of the photolithography mask and on further information describing the one or more selected predefined defects in a step G3; training the machine learning model for defect detection in photolithography masks using the generated aerial images and the one or more predefined defects in a step G4. In this way, training data including defects, that is usually hard to obtain, can be easily generated for training another machine learning model for defect detection.

A system 94 for generating an aerial image of a photolithography mask in an image space 36 according to an embodiment of the invention illustrated in FIG. 17 comprises: one or more processing devices 96; one or more machine-readable hardware storage devices 98 comprising instructions that are executable by one or more processing devices 96 to apply a method for generating an aerial image of a photolithography mask in an image space according to any one of the embodiments, aspects or examples described above. The one or more processing devices 96 can, for example, be implemented as a central processing unit (CPU), graphics processing unit (GPU) or tensor processing unit (TPU).

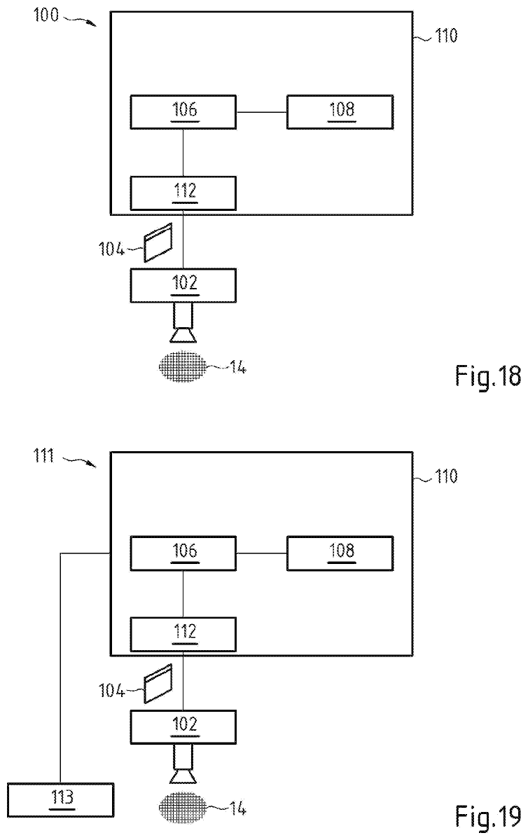

FIG. 18 illustrates a system 100 for localizing defects in a photolithography mask according to an embodiment of the invention comprising: a subsystem 102 for acquiring an aerial image 104 of the photolithography mask 14; a data analysis device 110 comprising at least one memory 108 and at least one processor 106 configured to perform the steps of the computer implemented method for localizing defects in a photolithography mask described above.

The subsystem 102 for acquiring an aerial image 104 of the photolithography mask can comprise an aerial image acquisition system. Alternatively, the subsystem 102 can comprise a database or any other memory comprising an aerial image 104 of the photolithography mask, and the subsystem 102 can be configured to load the aerial image 104 from the database or memory. The subsystem 102 for acquiring an aerial image 104 of the photolithography mask can provide an aerial image 104 to the data analysis device 110. The data analysis device 110 includes a processor 106, e.g., implemented as a CPU, GPU or TPU. The processor 106 can receive the aerial image 104 via an interface 112. The processor 106 can load program code from a memory 108, e.g., program code for executing a computer implemented method for localizing defects in a photolithography mask according to the embodiment described above. The processor 106 can execute the program code.

For example, the processor 106 can include one or more processor cores, and each processor core can include logic circuitry for processing data. For example, the processor 106 can include an arithmetic and logic unit (ALU), a control unit, and various registers. The processor 106 can include cache memory. The processor 106 can include a system-on-chip (SoC) that includes multiple processor cores, random access memory, graphics processing units, one or more controllers, and one or more communication modules. The processor 106 can include millions, billions or more of transistors.

For example, the processor can be configured to be suitable for the execution of a computer program and can be, by way of example, a general or a special purpose microprocessor, or any processor of any kind of digital computer. Generally, a processor will receive instructions and data from a read-only storage area or a random access storage area or both. The processor can be operatively coupled to receive data from, or transfer data to, or both, one or more machine-readable storage media, such as hard drives, magnetic disks, solid state drives, magneto-optical disks, or optical disks. Machine-readable storage media suitable for embodying computer program instructions and data include various forms of non-volatile storage area, including by way of example, semiconductor storage devices, e.g., EPROM, EEPROM, flash storage devices, and solid state drives; magnetic disks, e.g., internal hard disks or removable disks; magneto-optical disks; and CD-ROM, DVD-ROM, and/or Blu-ray discs.

In some implementations, the processes described above can be implemented using software for execution on one or more mobile computing devices, one or more local computing devices, and/or one or more remote computing devices (which can be, e.g., cloud computing devices). For instance, the software forms procedures in one or more computer programs that execute on one or more programmed or programmable computer systems, either in the mobile computing devices, local computing devices, or remote computing systems (which may be of various architectures such as distributed, client/server, grid, or cloud), each including at least one processor and at least one data storage system (including volatile and non-volatile memory and/or storage elements). Each computer system can include at least one input device or port, and at least one output device or port.

In some implementations, the software may be provided on a medium, such as CD-ROM, DVD-ROM, Blu-ray disc, a solid state drive, or a hard drive, readable by a general or special purpose programmable computer or delivered (encoded in a propagated signal) over a network to the computer where it is executed. The functions can be performed on a special purpose computer, or using special-purpose hardware, such as coprocessors. The software can be implemented in a distributed manner in which different parts of the computation specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system can also be considered to be implemented as a computer-readable storage medium, configured with a computer program, where the storage medium so configured causes a computer system to operate in a specific and predefined manner to perform the functions described herein.

FIG. 19 illustrates a system 111 for repairing a photolithography mask according to an embodiment of the invention comprising: a subsystem 102 for acquiring an aerial image 104 of the photolithography mask; a data analysis device 110 comprising at least one memory 108 and at least one processor 106 configured to perform the steps of the computer implemented method 89 for generating repair shapes for a photolithography mask described above.

The subsystem 102 for acquiring an aerial image 104 of the photolithography mask 14 can comprise an aerial image acquisition system. Alternatively, the subsystem 102 can comprise a database or any other memory comprising an aerial image 104 of the photolithography mask, and the subsystem 102 can be configured to load the aerial image 104 from the database or memory. The subsystem 102 for acquiring an aerial image 104 of the photolithography mask 14 can provide an aerial image 104 to the data analysis device 110. The data analysis device 110 includes a processor 106, e.g., implemented as a CPU, GPU or TPU. The processor 106 can receive the aerial image 104 via an interface 112. The processor 106 can load program code from a memory 108, e.g., program code for executing a computer implemented method for generating repair shapes for a photolithography mask according to the embodiment described above. The processor 106 can execute the program code. The system contains a repair system 113 for repairing the photolithography mask that uses the generated repair shapes. The generated repair shapes can, for example, be used to define regions of missing material or regions of excessive material deposition that can be corrected by the repair system 113.

In some implementations, the repair system 113 can repair the defects by, e.g., depositing materials on the photolithography mask using a deposition process, or removing materials from the photolithography mask using an etching process. Some defects can be repaired based on exposure with focused electron beams and adsorption of precursor molecules.

In some implementations, the repair system 113 can be configured to perform an electron beam-induced etching and/or deposition on the photolithography mask. The repair system 113 can include, e.g. an electron source, which emits an electron beam that can be used to perform electron beam-induced etching or deposition on the object. The repair system 113 can include mechanisms for deflecting, focusing and/or adapting the electron beam. The repair system 113 can be configured such that the electron beam is able to be incident on a defined point of incidence on the photolithography mask.

The repair system 113 can include one or more containers for providing one or more deposition gases, which can be guided to the photolithography mask via one or more appropriate gas lines. The repair system 113 can also include one or more containers for providing one or more etching gases, which can be provided on the photolithography mask via one or more appropriate gas lines. Further, the repair system 113 can include one or more containers for providing one or more additive gases that can be supplied to be added to the one or more deposition gases and/or the one or more etching gases.

The repair system 113 can include a user interface to allow an operator to, e.g., operate the repair system 113 and/or read out data.

The repair system 113 can include a computer unit configured to cause the repair system 113 to perform one or more of the methods described herein, based at least in part on an execution of an appropriate computer program.

In some implementations, the information about the defects serve as feedback to improve the process parameters of the manufacturing process for producing the photolithography masks. The process parameters can include, e.g., exposure time, focus, illumination, etc., For example, after the defects are identified from a first photolithography mask or first batch of photolithography masks, the process parameters of the manufacturing process are adjusted to reduce defects in a second mask or a second batch of masks.

In some implementations, a method for processing defects includes detecting at least one defect in a photolithography mask using the method for generating an aerial image of a photolithography mask using a machine learning model as described above, detecting the at least one defect using the generated aerial image as described above, and modifying the photolithography mask to at least one of reduce, repair, or remove the at least one defect.

For example, modifying the photolithography mask can include at least one of (i) depositing one or more materials onto the photolithography mask, (ii) removing one or more materials from the photolithography mask, or (iii) locally modifying a property of the photolithography mask.

For example, locally modifying a property of the photolithography mask can include writing one or more pixels on the photolithography mask to locally modify at least one of a density, a refractive index, a transparency, or a reflectivity of the photolithography mask.

In some implementations, a method of processing defects includes: processing a first photolithography mask using a manufacturing process that comprises at least one process parameter; detecting at least one defect in the first photolithography mask using the method for defect detection described above; and modifying the manufacturing process based on information about the at least one defect in the first photolithography mask that has been detected to reduce the number of defects or eliminate defects in a second photolithography mask to be produced by the manufacturing process.

For example, modifying the manufacturing process can include modifying at least one of an exposure time, focus, or illumination of the manufacturing process.

In some implementations, a method for processing defects includes: processing a plurality of regions on a first photolithography mask using a manufacturing process that comprises at least one process parameter, wherein different regions are processed using different process parameter values; applying the method for defect detection described above (e.g., generating an aerial image of a photolithography mask using a machine learning model, and detecting at least one defect using the generated aerial image as described above) to each of the regions to obtain information about zero or more defects in the region; identifying, using a quality criterion or criteria, a first region among the regions based on information about the zero or more defects; identifying a first set of process parameter values that was used to process the first region; and applying the manufacturing process with the first set of process parameter values to process a second photolithography mask.

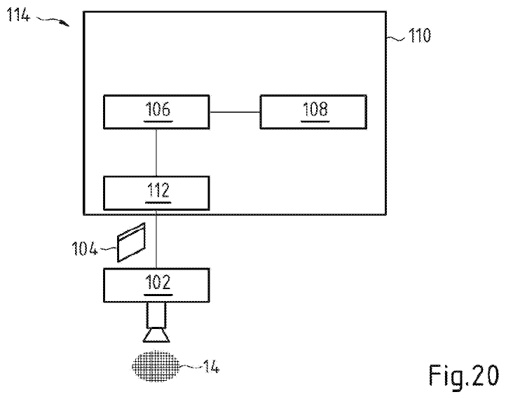

FIG. 20 illustrates a system 114 for aligning an aerial image 104 of a photolithography mask 14 to a representation of a design of the photolithography mask 14 according to an embodiment of the invention comprising: a subsystem 102 for acquiring an aerial image 104 of the photolithography mask 14; a data analysis device 110 comprising at least one memory 108 and at least one processor 106 configured to perform the steps of the computer implemented method for aligning an aerial image of a photolithography mask to a representation of a design of the photolithography mask described above.

The subsystem 102 for acquiring an aerial image 104 of the photolithography mask 14 can comprise an aerial image acquisition system. Alternatively, the subsystem 102 can comprise a database or any other memory comprising an aerial image 104 of the photolithography mask 14, and the subsystem 102 can be configured to load the aerial image 104 from the database or memory. The subsystem 102 for acquiring an aerial image 104 of the photolithography mask 14 can provide an aerial image 104 to the data analysis device 110. The data analysis device 110 includes a processor 106, e.g., implemented as a CPU, GPU or TPU. The processor 106 can receive the aerial image 104 via an interface 112. The processor 106 can load program code from a memory 108, e.g., program code for executing a computer implemented method for aligning an aerial image of a photolithography mask to a representation of a design of the photolithography mask according to the embodiment described above. The processor 106 can execute the program code.

Any of the systems described above can contain a user interface, e.g., for showing loss function plots, accuracy metrics, the training progress, or intermediate predictions to the user or for receiving input from the user, e.g., parameters of the conditional diffusion model such as the learning rate, architectural parameters, etc. Any of the systems described above can contain a database for loading and/or saving training data, validation data, intermediate results, pre-trained conditional diffusion models for further training, trained conditional diffusion models, e.g., for re-use in a different application, etc.

The embodiments and examples of the invention can be described by the following clauses:

1. A computer implemented method 20 for generating an aerial image 68 of a photolithography mask 14 in an image space 36, the method comprising:
a. Obtaining a representation 21 of a design of the photolithography mask 14; and
b. Applying a trained conditional diffusion model 33 that is configured to sequentially revert a stochastic process 70 to an initial sample 46 in order to generate an aerial image 68 of the photolithography mask 14, wherein the trained conditional diffusion model 33 is conditioned on the representation 21 of the design of the photolithography mask 14.

2. The method of clause 1, wherein the stochastic process 70 is a noising process.

3. The method of any one of the preceding clauses, wherein the initial sample 46 depends on the stochastic process 70 of the trained conditional diffusion model 33.

4. The method of any one of the preceding clauses, wherein the trained conditional diffusion model 33 is a trained latent conditional diffusion model 34, 34′ that operates in a latent space 48 of the image space 36 and that comprises a mapping 40 from the image space 36 to the latent space 48 and a mapping 66 from the latent space 48 to the image space 36.

5. The method of clause 4, wherein the trained latent conditional diffusion model 34, 34′ is conditioned on a representation 21 of the design of the photolithography mask 14 in latent space 48, and wherein the representation 21 of the design of the photolithography mask 14 in latent space 48 is obtained by applying a trained neural network to the representation 21 of the design of the photolithography mask 14.

6. The method of any one of the preceding clauses, wherein sequentially reversing the stochastic process 70 comprises applying a learned reverse stochastic process step 47 to the initial sample 46 in a first time step and to the result of the respective previous reverse stochastic process step 47 in all following time steps, wherein the learned reverse stochastic process step 47 reverses a time step of the stochastic process 70.

7. The method of clause 6, wherein the learned reverse stochastic process step 47 comprises a trained time-conditioned image-to-image neural network 58.

8. The method of clause 7, wherein the trained conditional diffusion model 33 is conditioned on the representation 21 of the design of the photolithography mask 14 by using one or more cross-attention layers 76 in the trained time-conditioned image-to-image neural network 58 to process the representation 21 of the design of the photolithography mask 14.

9. The method of any one of the preceding clauses, wherein the trained conditional diffusion model 33 is conditioned on the representation 21 of the design of the photolithography mask 14 by using the representation 21 of the design of the photolithography mask 14 as additional input to the trained conditional diffusion model 33.

10. The method of any one of the preceding clauses, wherein the trained conditional diffusion model 33 is conditioned on one or more further information 78 in addition to the representation 21 of the design of the photolithography mask 14.

11. The method of clause 10, wherein the further information 78 comprises information on an aerial image acquisition process.

12. The method of clause 10 or 11, wherein the further information 78 comprises information on an acquired aerial image.

13. The method of any one of clauses 10 to 12, wherein the further information 78 comprises information on the design of the photolithography mask 14.

14. The method of any one of the preceding clauses, wherein the condition of the trained conditional diffusion model 33 is indicated by use of images and/or text and/or parameters.

15. The method of any one of the preceding clauses, wherein the representation 21 of the design of the photolithography mask 14 describes the photolithography mask 14 at least partially in a dimension orthogonal to a base plane 15 of the photolithography mask 14.

16. A computer implemented method 80 for training a conditional diffusion model 33 for generating an aerial image 68 of a photolithography mask 14 in an image space 36 according to any one of the preceding clauses, the method comprising:
a. Obtaining training data comprising representations 21 of one or more designs of one or more photolithography masks 14 and one or more training images in the form of corresponding aerial images 38 of the one or more photolithography masks 14;
b. Applying one or more stochastic process steps 44 of the stochastic process 70 of the conditional diffusion model 33 to each of the training images, thereby generating transformed training images; and
c. Training the conditional diffusion model 33 to recover the training images 38 from the transformed training images by carrying out iterations 84 comprising:
   i. Presenting one or more transformed training images 38 to the conditional diffusion model 33 that is conditioned on the corresponding representation 21 of the design of the photolithography mask 14, thereby obtaining one or more outputs of the conditional diffusion model 33; and
   ii. Modifying the parameters of the conditional diffusion model 33 to optimize an objective function.

17. The method of clause 16, wherein the conditional diffusion model 33 is a latent conditional diffusion model 34, 34′ that operates in a latent space 48 of the image space 36 and that comprises a mapping 40 from the image space 36 to the latent space 48 and a mapping 66 from the latent space 48 to the image space 36, and wherein the training images are mapped to the latent space 48 in step a.

18. A computer implemented method 86 for localizing defects in a photolithography mask 14, the method comprising:
a. Acquiring an aerial image 38 of the photolithography mask 14;
b. Applying a computer implemented method 20 for generating an aerial image 68 of the photolithography mask 14 in an image space 36 according to any one of clauses 1 to 17, wherein the acquired aerial image 38 is used as representation 21 of the design of the photolithography mask 14; and
c. Localizing defects by comparing the acquired aerial image 38 to the generated aerial image 68.

19. A computer implemented method 88 for aligning an aerial image 38 of a photolithography mask 14 to a representation 21 of a design of the photolithography mask 14 for use of the alignment in photolithography mask defect detection or repair, the method comprising:
a. Acquiring the aerial image 38 of the photolithography mask 14;
b. Applying a computer implemented method 20 for generating an aerial image 68 of the photolithography mask 14 in an image space 36 according to any one of clauses 1 to 17; and
c. Aligning the acquired aerial image 38 and the generated aerial image 68 by solving an optimization problem.

20. A computer implemented method 89 for generating repair shapes for a photolithography mask 14, the method comprising:
a. Acquiring an aerial image 38 of the photolithography mask 14;
b. Applying a computer implemented method 20 for generating an aerial image 68 of the photolithography mask 14 in an image space 36 according to any one of clauses 1 to 17, wherein the acquired aerial image 38 is used as representation 21 of the design of the photolithography mask 14; and
c. Comparing the acquired aerial image 38 to the generated aerial image 68 to derive repair shapes from the deviations, for use of the repair shapes for repairing the photolithography mask 14.

21. A computer program comprising instructions which, when the program is executed by a computer, cause the computer to carry out a method according to any one of the preceding clauses.

22. A computer-readable medium, on which a computer program executable by a computing device is stored, the computer program comprising code for executing a method according to any one of the preceding method clauses.

23. A system 94 for generating an aerial image 68 of a photolithography mask 14, the system comprising:
a. one or more processing devices 96; and
b. one or more machine-readable hardware storage devices 98 comprising instructions that are executable by one or more processing devices to apply a method 20 for generating an aerial image 68 of a photolithography mask 14 according to any one of clauses 1 to 17.

24. A system 100 for localizing defects in a photolithography mask 14, the system comprising:
a. a subsystem 102 for acquiring an aerial image 38 of the photolithography mask 14; and
b. a data analysis device 110 comprising at least one memory 108 and at least one processor 106 configured to perform the steps of the computer implemented method 86 for localizing defects in a photolithography mask 14 according to clause 18.

25. A system 114 for aligning an aerial image 38 of a photolithography mask 14 to a representation 21 of a design of the photolithography mask 14, the system comprising:
a. a subsystem 102 for acquiring an aerial image 38 of the photolithography mask 14; and
b. a data analysis device 110 comprising at least one memory 108 and at least one processor 106 configured to perform the steps of the computer implemented method 88 for aligning an aerial image 38 of a photolithography mask 14 to a representation 21 of a design of the photolithography mask 14 according to clause 19.

26. A system 111 for repairing a photolithography mask 14, the system comprising:
a. a subsystem 102 for acquiring an aerial image 38 of the photolithography mask 14;
b. a data analysis device 110 comprising at least one memory 108 and at least one processor 106 configured to perform the steps of the computer implemented method 89 for generating repair shapes for a photolithography mask 14 according to clause 20; and
c. a repair system 113 for repairing the photolithography mask 14 that uses the generated repair shapes.

In summary, an aspect of the invention relates to a computer implemented method 20 for generating an aerial image 68 of a photolithography mask 14 in an image space 36, the method comprising: obtaining a representation 21 of a design of the photolithography mask 14; applying a trained conditional diffusion model 33 that is configured to revert a stochastic process 70 to an initial sample in order to generate an aerial image 68 of the photolithography mask 14, wherein the trained conditional diffusion model 33 is conditioned on the representation 21 of the design of the photolithography mask 14. The invention also relates to computer implemented methods for defect localization, alignment, repair shape generation, training data generation and corresponding systems.

### REFERENCE NUMBER LIST

10, 10′ Photolithography system
12 Radiation source
14 Photolithography mask
15 Base plane
16 Illumination optics
17 Projection optics
18 Wafer plane
19 Projection section
20 Computer implemented method
21 Representation
22 Structures
24 Absorber structures
26 Multilayer
28 Bounding box
30 Semantic map
32 Section
33 Conditional diffusion model
34, 34′ Latent conditional diffusion model
36 Image space
38 Aerial image
40 Mapping
42 Latent representation
44 Stochastic process step
46 Transformed sample
47 Reverse stochastic process step
48 Latent space
50 Concatenation
52 CAD file
56 Reverse stochastic process
58 Image-to-image neural network
60 Sequence
62 Denoised sample
64 Latent representation
66 Mapping
68 Generated aerial image
70 Stochastic process
72 Cross-attention layer
74 First set of tokens
75 Second set of tokens
76 Cross-attention based representation
78 Further information
79 Acquired aerial image
80 Computer implemented method
82 Iteration
84 Iteration
86 Computer implemented method
88 Computer implemented method
89 Computer implemented method
90 Computer implemented method
92 Iteration
94 System
96 Processing device
98 Hardware storage device
100 System
102 Subsystem
104 Aerial image
106 Processor
108 Memory
110 Data analysis device
111 System
112 Interface
113 Repair system
106 System
108 Subsystem
110 Charged particle beam image
112 Interface
114 System

What is claimed is:

1. A computer implemented method for generating an aerial image of a photolithography mask in an image space, the method comprising:
a. obtaining a representation of a design of the photolithography mask; and
b. applying a trained conditional diffusion model that is configured to sequentially revert a stochastic process to an initial sample in order to generate an aerial image of the photolithography mask, wherein the trained conditional diffusion model is conditioned on the representation of the design of the photolithography mask.

2. The method of claim 1, wherein the stochastic process is a noising process.

3. The method of claim 1, wherein the initial sample depends on the stochastic process of the trained conditional diffusion model.

4. The method of claim 1, wherein the trained conditional diffusion model is a trained latent conditional diffusion model that operates in a latent space of the image space and that comprises a mapping from the image space to the latent space and a mapping from the latent space to the image space.

5. The method of claim 4, wherein the trained latent conditional diffusion model is conditioned on a representation of the design of the photolithography mask in latent space, and wherein the representation of the design of the photolithography mask in latent space is obtained by applying a trained neural network to the representation of the design of the photolithography mask.

6. The method of claim 1, wherein sequentially reversing the stochastic process comprises applying a learned reverse stochastic process step to the initial sample in a first time step and to the result of the respective previous reverse stochastic process step in all following time steps, wherein the learned reverse stochastic process step reverses a time step of the stochastic process.

7. The method of claim 6, wherein the learned reverse stochastic process step comprises a trained time-conditioned image-to-image neural network.

8. The method of claim 7, wherein the trained conditional diffusion model is conditioned on the representation of the design of the photolithography mask by using one or more cross-attention layers in the trained time-conditioned image-to-image neural network to process the representation of the design of the photolithography mask.

9. The method of claim 1, wherein the trained conditional diffusion model is conditioned on the representation of the design of the photolithography mask by using the representation of the design of the photolithography mask as additional input to the trained conditional diffusion model.

10. The method of claim 1, wherein the trained conditional diffusion model is conditioned on one or more further information in addition to the representation of the design of the photolithography mask.

11. The method of claim 10, wherein the further information comprises information on an aerial image acquisition process.

12. The method of claim 10, wherein the further information comprises information on an acquired aerial image.

13. The method of claim 10, wherein the further information comprises information on the design of the photolithography mask.

14. The method of claim 1, wherein the condition of the trained conditional diffusion model is indicated by use of images and/or text and/or parameters.

15. The method of claim 1, wherein the representation of the design of the photolithography mask describes the photolithography mask at least partially in a dimension orthogonal to a base plane of the photolithography mask.

16. A computer implemented method for training a conditional diffusion model for generating an aerial image of a photolithography mask in an image space according to claim 1, the method comprising:
a. obtaining training data comprising representations of one or more designs of one or more photolithography masks and one or more training images in the form of corresponding aerial images of the one or more photolithography masks;
b. applying one or more stochastic process steps of the stochastic process of the conditional diffusion model to each of the training images, thereby generating transformed training images; and
c. training the conditional diffusion model to recover the training images from the transformed training images by carrying out iterations comprising:
i. presenting one or more transformed training images to the conditional diffusion model that is conditioned on the corresponding representation of the design of the photolithography mask, thereby obtaining one or more outputs of the conditional diffusion model; and
ii. modifying the parameters of the conditional diffusion model to optimize an objective function.

17. The method of claim 16, wherein the conditional diffusion model is a latent conditional diffusion model that operates in a latent space of the image space and that comprises a mapping from the image space to the latent space and a mapping from the latent space to the image space, and wherein the training images are mapped to the latent space in step a.

18. A computer implemented method) for localizing defects in a photolithography mask, the method comprising:
a. acquiring an aerial image of the photolithography mask;
b. applying a computer implemented method for generating an aerial image of the photolithography mask in an image space according to claim 1, wherein the acquired aerial image is used as representation of the design of the photolithography mask; and
c. localizing defects by comparing the acquired aerial image to the generated aerial image.

19. A computer implemented method for aligning an aerial image of a photolithography mask to a representation of a design of the photolithography mask for use of the alignment in photolithography mask defect detection or repair, the method comprising:
a. acquiring the aerial image of the photolithography mask;
b. applying a computer implemented method for generating an aerial image of the photolithography mask in an image space according to claim 1; and
c. aligning the acquired aerial image and the generated aerial image by solving an optimization problem.

20. A computer implemented method for generating repair shapes for a photolithography mask, the method comprising:
a. acquiring an aerial image of the photolithography mask;
b. applying a computer implemented method for generating an aerial image of the photolithography mask in an image space according to claim 1, wherein the acquired aerial image is used as representation of the design of the photolithography mask; and
c. comparing the acquired aerial image to the generated aerial image to derive repair shapes from the deviations, for use of the repair shapes for repairing the photolithography mask.

21. A computer program comprising instructions which, when the program is executed by a computer, cause the computer to carry out a method according to claim 1.

22. A computer-readable medium, on which a computer program executable by a computing device is stored, the computer program comprising code for executing a method according to claim 1.

23. A system for generating an aerial image of a photolithography mask, the system comprising:
a. one or more processing devices;
b. one or more machine-readable hardware storage devices comprising instructions that are executable by one or more processing devices to apply a method for generating an aerial image of a photolithography mask according to claim 1.

24. A system for localizing defects in a photolithography mask, the system comprising:
a. a subsystem for acquiring an aerial image of the photolithography mask;
b. a data analysis device comprising at least one memory and at least one processor configured to perform the steps of the computer implemented method for localizing defects in a photolithography mask according to claim 18.

25. A system for aligning an aerial image of a photolithography mask to a representation of a design of the photolithography mask, the system comprising:
a. a subsystem for acquiring an aerial image of the photolithography mask; and
b. a data analysis device comprising at least one memory and at least one processor configured to perform the steps of the computer implemented method for aligning an aerial image of a photolithography mask to a representation of a design of the photolithography mask according to claim 19.

26. A system for repairing a photolithography mask, the system comprising:
a. a subsystem for acquiring an aerial image of the photolithography mask;
b. a data analysis device comprising at least one memory and at least one processor configured to perform the steps of the computer implemented method for generating repair shapes for a photolithography mask according to claim 20; and
c. a repair system for repairing the photolithography mask that uses the generated repair shapes.
